(19) United States
(12) Patent Application Publication
(10) Pub. No.: US 2012/0175467 A1
(43) Pub. Date: Jul. 12, 2012

(54) MICROMETEOROID AND ORBITAL DEBRIS (MMOD) AND INTEGRATED MULTI-LAYER INSULATION (IMLI) STRUCTURE

(75) Inventors: Scott Dye, Morrison, CO (US); Alan Kopelove, Evergreen, CO (US)

(73) Assignee: QUEST PRODUCT DEVELOPMENT CORPORATION, Arvada, CO (US)

(21) Appl. No.: 13/313,723

(22) Filed: Dec. 7, 2011

Related U.S. Application Data
(63) Continuation-in-part of application No. 12/493,852, filed on Jun. 29, 2009.

(51) Int. Cl. B64G 1/56; B23P 11/00; B64G 1/58

(52) U.S. Cl. 244/171.7; 29/428

(57) ABSTRACT

A micrometeoroid and orbital debris-integrated multi-layer insulation (MMOD/IMLI) structure including at least one ballistic layer, which may be flexible, and at least one insulation layer, which may also be flexible is described. The ballistic layer or layers and the insulation layer or layers may be separated by a plurality of spacers. In one example, the spacers include a leg extending obliquely between the ballistic layer and the insulation layer. The spacer may include three deformable legs defining a tri-pod configuration with the tri-pod configuration including a ring supporting the legs.

### CROSS-REFERENCE TO RELATED APPLICATION

This application is a continuation-in-part of U.S. patent application Ser. No. 12/493,852 entitled “Integrated Multilayer Insulation” filed on Jun. 29, 2009, which is hereby incorporated by reference in its entirety.

### TECHNICAL FIELD

The present disclosure relates to micrometeoroid and orbital debris shielding and thermal management of exposed equipment surfaces associated with space missions.

### BACKGROUND

For space and low Earth orbit (LEO) missions, micrometeoroid and orbital debris (MMOD) protection for exposed equipment surfaces associated with spacecraft, space-borne instruments, space stations and orbiting fuel depots is critical to mission safety and success. There are numerous documented cases of MMOD damage causing critical equipment mission impairment or failure in space. Moreover, the risk of damage to equipment from orbital debris (OD) steadily increases with the ever-increasing amount of orbital debris resulting from space missions and space defense operations.

A number of existing MMOD protective shields have a Whipple-type design that include an exposed aluminum front bumper shield and an aluminum rear wall held at a fixed spacing by rigid standoffs. These shields, which may further include layers of KEVLAR and/or NEXTEL material, are referred to as Stuffed Whipple Shields. The effectiveness of the Whipple-type shields, as well as other multi-layer shield designs, is sensitive to the separation distance between the exposed bumper shield and the rear wall of the MMOD shield. Additionally, the rigid metal standoffs necessary to maintain separation between the bumper shield and the rear wall are thermally conductive and add additional weight to the Whipple-type shields. Further, the heavy materials of standoffs may introduce undesired additional debris ejecta as a result of particle impact on the standoff due to the spalling of the underside of the front bumper or due to damage to one of the shield's metal structural standoffs.

Another category of existing MMOD protective shield designs, the multishock shield design, replaces the aluminum front bumper of the Whipple-type shield with a series of NEXTEL bumpers as well as a single or multiple internal aluminum bumpers and a Whipple-type aluminum rear wall. Although the weight and damaging secondary ejecta associated with particle impacts to the multishock shield design are reduced relative to the Whipple-type shields, the multishock shields also require heavy and thermally conductive structural standoffs to maintain separation between layers. None of the Whipple-type shield, Stuffed Whipple Shield, or multishock shield designs provides the thermal insulation required for many spacecraft, satellite and space-borne instrument applications.

Multilayer insulation (MLI) blankets have also been used to provide some measure of protection against micrometeoroid and orbital debris impacts in addition to the MLI blanket's primary function of providing a barrier against thermal radiation and conduction. MLI blankets typically include multiple layers of thin KAPTON or MYLAR material and may further include one or more outer layers of a reinforcing material, such as NEXTEL, to enhance the MLI blanket's ability to shield the underlying structure against micrometeoroid and orbital debris impacts. Despite having a relatively low areal density (i.e. mass per unit area of shielding material), MLI blankets provide limited protection against micrometeoroid and orbital debris impacts. However, this low areal density also limits the MLI blanket's ability to stop heavier orbital debris, thus precluding the use of MLI blankets as the sole MMOD shield for an orbiting device or vehicle. In addition, because MLI blankets typically lack rigid structural standoffs to maintain a precise separation distance between layers, the separation between layers may vary considerably, resulting in relatively unpredictable layer spacing, which may influence the MLI blanket's effectiveness as a MMOD shield.

A need exists for a structure that integrates the elements of a MMOD shield, while inhibiting the transfer of thermal energy between the equipment to be protected by the structure and the surrounding volume. In addition, the need exists for an integrated MMOD shield and thermal radiation barrier that is relatively lightweight and compressible to facilitate transport, and that may be deployed into a structure having predictable and controlled separation between layers using simple tools.

The foregoing examples of the related art and limitations read therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect of the present invention, a micrometeoroid and orbital debris/integrated multi-layer insulation (MMOD/IMLI) structure is provided. The MMOD/IMLI structure includes a first ballistic layer, a plurality of first spacers supporting the first ballistic layer, and an IMLI sub-assembly. The IMLI sub-assembly includes a first thermal radiative barrier layer, a plurality of second spacers supporting the first thermal radiative barrier layer, a second thermal radiative barrier layer adjacent to the plurality of second spacers opposite to the first thermal radiative barrier layer and a plurality of third spacers supporting the second thermal radiative barrier layer. The MMOD/IMLI structure simultaneously provides shielding against high-velocity projectiles and thermal insulation to the equipment surface.

In another aspect, a method for simultaneously insulating an equipment item that includes an equipment surface as well as shielding the equipment surface against high-velocity projectiles is provided. The method includes providing an MMOD/IMLI structure and situating the MMOD/IMLI structure over the equipment surface. The MMOD/IMLI structure includes a ballistic layer and an IMLI sub-assembly. The IMLI sub-assembly includes a lower IMLI surface and a plurality of spacers supporting the lower IMLI surface; the plurality of spacers are arranged in a grid pattern.

In an additional aspect, a micrometeoroid and orbital debris/integrated multi-layer insulation (MMOD/IMLI) structure is provided that includes at least one flexible ballistic layer and at least one flexible thermal insulation layer. The at least one flexible ballistic layer and the at least one flexible thermal insulation layer are separated by a plurality of spacers. The plurality of spacers define at least one leg extending obliquely between the at least one flexible ballistic layer and the at least one flexible thermal insulation layer.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is a cross-sectional view of an MMOD/IMLI structure in a deployed configuration.

FIG. 2 is an illustration of a particle collision with an MMOD/IMLI structure.

FIG. 3 is a cross-sectional view of an MMOD/IMLI structure in a deployed configuration with a staggered spacer pattern.

FIG. 4 is a perspective view of a spacer in an uncompressed state.

FIG. 5 is a perspective view of a spacer in a compressed state.

FIG. 6 is a cross-sectional view of an MMOD/IMLI structure in a compressed configuration.

FIG. 7 is a perspective view of a spacer in an uncompressed state.

FIG. 8 is a side view of spacers in a compressed state between two layers of an MMOD/IMLI structure.

FIG. 9 is a side view of spacers in an uncompressed state between two layers of an MMOD/IMLI structure.

FIG. 10 is a photograph of several KEVLAR and NEXTEL ballistic layers mounted in support frames prior to assembly into ballistic coupons that were subjected to high-velocity impact (HVI) testing.

FIG. 11 is a photograph of a scored sheet of IMLI layers fabricated into layered sub-assemblies prior to cutting the sheet into individual 8″×8″ square IMLI sub-assemblies.

FIG. 12 is a photograph of a layered IMLI sub-assembly attached to a base plate during the assembly of a ballistic coupon to be subjected to HVI testing.

FIG. 13 is a photograph showing the application of adhesive to an ULTEM tripod spacer on the upper surface of a KEVLAR ballistic layer in preparation for bonding a layered IMLI sub-assembly during the assembly of a ballistic coupon to be subjected to HVI testing.

FIG. 14 is a photograph of the assembled ballistic coupon used in projectile impact testing showing the exposed upper NEXTEL ballistic layer.

FIG. 15 is a photograph of the assembled ballistic coupon used in projectile impact testing showing the IMLI sub-assemblies layered between the ballistic layers.

FIGS. 16A-16C are photographs of the first ballistic layer of a ballistic coupon after impact to the coupon by a 5.4 mm projectile traveling at 6.63 km/s. FIG. 16A shows the exterior impact surface. FIG. 16B is a close-up photograph of the region of projectile entry on the exterior impact surface and FIG. 16C is a close-up photograph of the region of projectile exit.

FIGS. 17A-17C are photographs of the uppermost IMLI sub-assembly layer #1 of a ballistic coupon after impact to the coupon by a 5.4 mm projectile traveling at 6.63 km/s. FIG. 17A shows the particle impact surface. FIG. 17B is a close-up of the region of projectile entry and FIG. 17C is a close-up of the region of projectile exit.

FIGS. 18A-18C are photographs of ballistic layer #11 of a ballistic coupon after impact to the coupon by a 5.4 mm projectile traveling at 6.63 km/s. FIG. 18A shows the particle impact surface. FIG. 18B is a close-up of the region of projectile entry and FIG. 18C is a close-up of the region of projectile exit.

FIGS. 19A and 19B are photographs of IMLI sub-assembly layer #11 of a ballistic coupon after impact to the coupon by a 5.4 mm projectile traveling at 6.63 km/s. FIG. 19A is a close-up of the region of projectile entry and FIG. 19B is a close-up of the region of projectile exit.

FIGS. 20A-20C are photographs of ballistic layer #12 of a ballistic coupon after impact to the coupon by a 5.4 mm projectile traveling at 6.63 km/s. FIG. 20A shows the particle impact surface. FIG. 20B is a close-up of the region of projectile impact and FIG. 20C is a close-up of the region of projectile impact; no particles associated with the projectile impact to the coupon physically penetrated this layer.

FIGS. 21A and 21B are photographs of IMLI sub-assembly layer #12 of a ballistic coupon after impact to the coupon by a 5.4 mm projectile traveling at 6.63 km/s. FIG. 21A is a photograph of the upper surface of the IMLI sub-assembly layer and FIG. 21B is a close-up of the layer's upper surface showing dust particles of the adjacent Kevlar ballistic layer.

FIG. 22 is a photograph of an inner layered IMLI sub-assembly attached to the outer surface of a 20 L test calorimeter during fabrication of a test article for thermal performance testing.

FIG. 23 is a photograph of the end view of an inner layered IMLI sub-assembly end cap attached to the end of a 20 L test calorimeter during fabrication of a test article for thermal performance testing.

FIG. 24 is a photograph of a KEVLAR ballistic layer placed over an inner IMLI sub-assembly during fabrication of a test article for thermal performance testing.

FIG. 25 is a photograph of an outer layered IMLI sub-assembly placed over a KEVLAR ballistic layer during fabrication of a test article for thermal performance testing.

FIG. 26 is a photograph of a completed test article for thermal performance testing showing an outer NEXTEL ballistic layer.

FIG. 27 is a top view of spacers interconnected by beams.

Corresponding reference characters and labels indicate corresponding elements among the view of the drawings. The headings used in the figures should not be interpreted to limit the scope of the claims.

### DETAILED DESCRIPTION

A Micrometeoroid Orbital Debris Integrated Multi layer Insulation (MMOD/IMLI) structure is provided that overcomes many of the existing MMOD shield limitations and provides both MMOD protection and thermal management not achievable by any single conventional shield or insulation structure. The MMOD/IMLI structure provides a multifunctional MMOD/protective and thermal management structure for use on spacecraft, orbital fuel depots, space-borne instruments, space laboratories or habitats, satellites, as well as terrestrial applications including ballistic shields and insulation. The MMOD/IMLI structures may be used to protect equipment operating within the Earth's atmosphere, in low Earth orbit, in lunar orbit, and in any other terrestrial or space-based environment. The MMOD/IMLI structure includes one or more IMLI layers or sub-assemblies and one or more ballistic layers arranged in an interspersed and layered pattern. Each IMLI sub-assembly may include one or more layers of thermal radiant barriers including, but not limited to, metalized MYLAR sheets. Each ballistic layer may include one or more layers of high-strength ballistic material including, but not limited to, KEVLAR and/or NEXTEL.

In addition, the adjacent layers of material within the MMOD/IMLI structure may be physically attached to one another or otherwise separated and supported by way of discrete spacers. These spacers also maintain a separation distance between the adjacent layers of the MMOD/IMLI structure to provide controlled, repeatable, layer-to-layer spacing in a robust self-supporting structure. The spacers are typically constructed of a lightweight and high strength material and are situated in a predetermined pattern to reduce thermal conduction from layer to layer and to enhance structural integrity.

In use, the IMLI subassemblies of the MMOD/IMLI structure may be configured to inhibit the gains and losses of thermal energy to and from the equipment to be protected by the structure, and the ballistic layers are configured to provide impact protection against projectiles including, but not limited to, micrometeoroids and/or orbiting debris. However, the IMLI sub-assemblies may further provide limited protection against projectiles, and the ballistic layers may further provide limited insulative properties. The MMOD/IMLI structure derives a synergistic benefit as a result of the incorporation of the IMLI sub-assemblies and ballistic layers in a single integrated structure. This synergistic benefit further results in enhanced performance, reduced weight, and reduced volume of the MMOD/IMLI structure relative to existing separate MMOD shields and thermal protection structures.

The IMLI sub-assemblies and ballistic layers of the MMOD/IMLI structure are modular by design and may be arranged in virtually any configuration according to need. The MMOD/IMLI structure may be configured to fulfill mission-specific requirements for both thermal and impact protection requirements, among other requirements. These mission-specific requirements may be based on any one or more of at least several factors, including but not limited to: the duration of the mission, the characteristics of the equipment to be protected by the MMOD/IMLI structure, the altitude and inclination of the equipment in orbit, the MMOD fluence (i.e. debris flux) at the given altitude and inclination of the equipment, the probability of no penetration (PNP) requirement for the mission, the critical particle diameter to be protected against, other relevant characteristics of the mission environment such as solar flares, and any combination thereof.

Typically, thermal performance criteria will govern the design and arrangement of the IMLI sub-assemblies in the MMOD/IMLI structure. Similarly, impact protection requirements including, but not limited to, PNP requirements may govern the design and arrangement of the ballistic layers in the MMOD/IMLI structure. The ballistic layers and IMLI sub-assemblies may be configured in any order, number or thickness to meet application requirements.

For example, the mission-specific requirements for cryogenic applications including, but not limited to, orbiting cryogenic propellant tanks may include: the probability of penetration by projectiles over its mission duration, current MMOD fluence for the mission location, and the thermal requirements to minimize cryogenic propellant boil-off from the tank over the duration of the mission. The MMOD fluence may be combined with characteristics of the equipment including, but not limited to, the spacecraft area and geometric factors to estimate the probability of projectile impacts. The controlled inter-layer spacing and repeatable configuration of the MMOD/IMLI structure enhances the accuracy of the modeling of ballistic and thermal performance, thereby facilitating the process of designing the MMOD/IMLI structure.

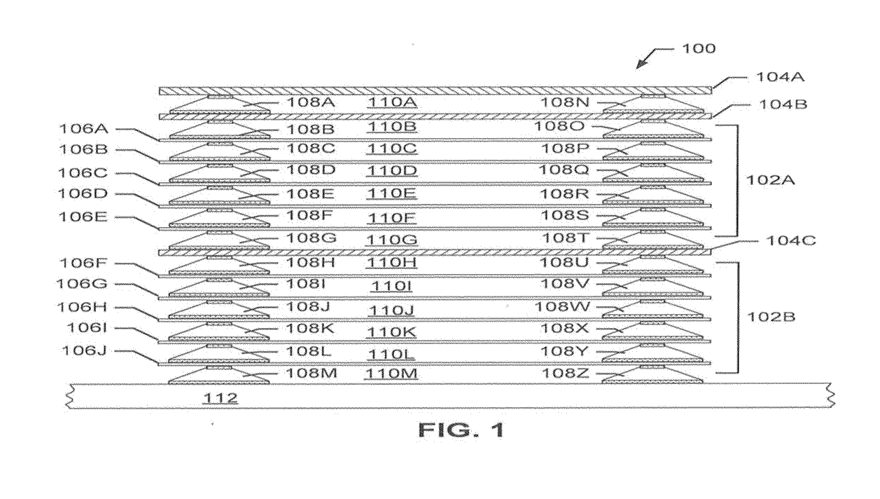

An embodiment of a MMOD/IMLI structure 100 is illustrated in FIG. 1. The MMOD/IMLI structure 100 includes one or more IMLI sub-assemblies 102A and 102B, as well as one or more ballistic layers 104A-104C. The materials of the ballistic layers 104A-104C may be arranged to enhance the projectile-shielding properties of the MMOD/IMLI structure 100. In this embodiment, an outer ballistic layer 104A may be constructed from a high strength material, such as NEXTEL ceramic fabric, in order to fragment a projectile upon impact, and the inner layers 104B and 104C may be formed from an energy-absorbent material, such as KEVLAR, to arrest the further penetration of the projectile fragments.

A plurality of discrete spacers 108A-108Z separate and support each of the adjacent layers, including the thermal radiant barrier layers 106A-106J and ballistic layers 104A-104C. Each of the plurality of discrete spacers 108A-108Z is attached to the layers situated immediately above and below of each spacer 108A-108Z, resulting in the attachment of all layers of the MMOD/IMLI structure 100 to form a single integrated structure. In addition, the discrete spacers 108A-108Z maintain the adjacent layers at a predetermined distance, forming interlayer volumes 110A-110M bounded by the corresponding layers situated immediately above and below the interlayer volumes 110A-110M.

In one aspect, the lowermost spacers 108M and 108Z may be attached to both the lowermost layer 106J and to the underlying equipment surface 112, thereby attaching the MMOD/IMLI structure 100 to the equipment to be protected and insulated, as illustrated in FIG. 1. The equipment surface 112, for example, may be the outer wall of a cryogenic propellant tank or equipment housing. In another aspect, the lowermost spacers 108M and 108Z may be attached to a sheet layer, such as a MYLAR sheet, surrounding the equipment. In yet another aspect, the lowermost spacers 108M and 108Z may be omitted, and the MMOD/IMLI structure 100 may rest without attachment on top of the equipment surface 112 or on top of a sheet layer surrounding the equipment.

Aspects of the MMOD/IMLI structure, including the ballistic layers, IMLI sub-assemblies, and spacers, as well as methods of producing the MMOD/IMLI structure are described in detail below.

### I. Ballistic Layers

The MMOD protection imparted by the MMOD/IMLI structure is influenced by the distribution of the ballistic layers throughout the structure. The MMOD/IMLI structure may be designed to stop high-velocity projectiles within the layers of the MMOD/IMLI structure or prior to full penetration of the underlying equipment surface. Non-limiting examples of high-velocity projectiles for which the MMOD/IMLI structure may be designed to stop include micrometeoroids and orbital debris. In some cases, limited damage to the protected equipment may be tolerated without compromising the function of the equipment. In these cases, the MMOD/IMLI structure may be designed to reduce the impact of high-velocity projectiles to within allowable ranges.

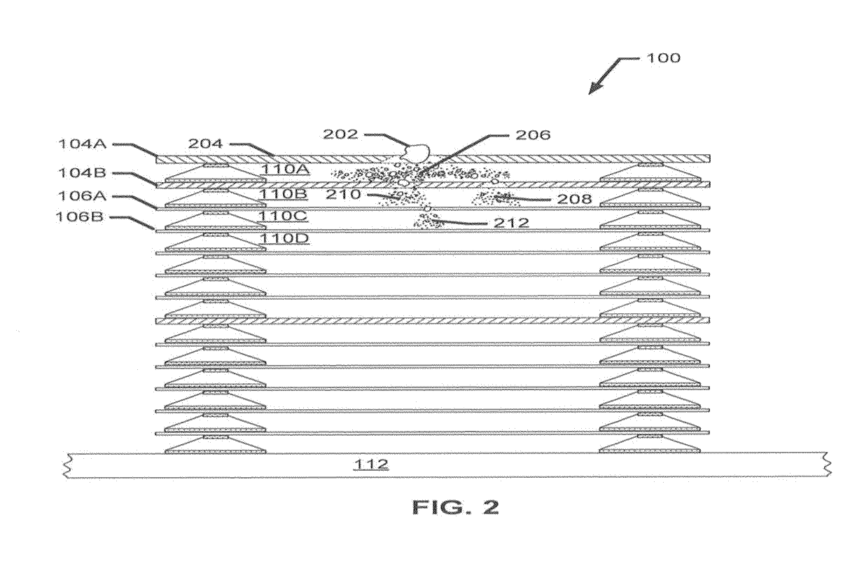

Without being limited to any particular theory, in one aspect the ballistic layers and the IMLI sub-assemblies are designed to break up the incoming particle or change the particle's state, thus generating smaller particles, a debris cloud, and/or a plasma. FIG. 2 is an illustration of the impact of a high-velocity projectile 202 (not to scale) on the upper surface 204 of the ballistic layer 104A of a MMOD/IMLI structure 100. Upon impact, the projectile 202 perforates the ballistic layer 104A. Because the ballistic layer 104A is constructed of a high-strength material including, but not limited to NEXTEL or KEVLAR, the energy required to perforate the ballistic layer 104A is sufficiently high to induce the fracturing of the projectile 202 into smaller fragments, and/or to change the phase of at least a fraction of the projectile 202 from a solid phase into a liquid (molten) phase or plasma phase. In addition, the impact of the projectile 202 may generate debris ejecta comprising fractured particles of material from the ballistic layer 104A.

Due to the momentum of the impact, a primary debris cloud 206 formed from the combination of particle fragments and ballistic layer fragments may pass into the interlayer volume 110A. The fragments within the primary debris cloud 206 may include fragments with a variety of sizes and masses, and individual fragments may be in a solid phase, liquid phase, and/or plasma phase. Because a significant amount of energy is absorbed by the ballistic layer 104A at impact and the mass of the fragments is reduced relative to the original projectile 202, the fragments within the primary debris cloud 206 travel at a velocity that may be significantly slower than the impact velocity of the original projectile 202. As a result, the impact of the fragments within the primary debris cloud 206 is less likely to penetrate the underlying ballistic layer 104B.

In some cases, one of more of the fragments within the primary debris cloud 206 may possess sufficient mass and velocity to perforate the underlying ballistic layer 104B in one or more regions. In this case, secondary debris clouds 208 and 210 may pass through the ballistic layer 104B into the interlayer volume 110B. The radiant barrier layer 106A beneath ballistic layer 104B may stop all particles of the secondary debris cloud 208, as illustrated in FIG. 2. One or more particles within secondary debris cloud 210 may pass through radiant barrier layer 106A, forming a tertiary debris cloud 212 within interlayer volume 110C. Due to the energy losses associated with perforating layers 104A, 104B, and 106A, none of the particles within tertiary debris cloud 212 may possess sufficient mass and/or velocity to perforate radiant barrier layer 106B. As a net result, the MMOD/IMLI structure 100 prevented the high velocity projectile from impacting the underlying equipment surface 112.

Although the penetration of three layers of the MMOD/IMLI structure 100 are illustrated in FIG. 2, any number of projectiles 202 and any number of debris clouds resulting from the impact of the projectiles 202 may impact and/or penetrate any number of layers of the MMOD/IMLI structure 100 without limit in various other aspects. In these various other aspects, the design of MMOD/IMLI structure 100 may incorporate sufficient numbers and/or thicknesses of ballistic layers and/or IMLI sub-assembly layers to prevent the impact of any number of projectiles 202 and/or debris clouds upon the underlying equipment surface 112, and/or prevent the impact of some predicted or measured range of particles, particle sizes, and/or particle velocities within some margin of error. Any projectile 202 and/or associated debris clouds may penetrate the layers of the MMOD/IMLI structure 100 until sufficient energy has been dissipated to completely stop the projectiles 202 and debris clouds.

The primary stopping power of the MMOD/IMLI structure may be influenced by factors including, but not limited to, layer spacing and the strength and tenacity of the materials of the ballistic layers. In addition, the radiant barrier layers of the IMLI sub-assemblies may enhance the stopping power of the MMOD/IMLI structure. Clearly, the size, velocity and angle of impact of the projectile may further affect the stopping power of the MMOD/IMLI structure.

In an aspect, the materials and dimensions of the ballistic layers may be selected in order to enhance the stopping power of the MMOD/IMLI structure. For example, the upper ballistic layers (those nearer the impact surface 104A) of the MMOD/IMLI structure may be formed from a more rigid or layered material in order to induce the fragmentation and/or phase change of an incoming projectile upon impact. In addition, the lower ballistic layers (those nearer the equipment surface to be protected and insulated) may be formed from a more resilient material capable of absorbing energy through deformation of the ballistic layer in order to enhance the stopping power of the lower ballistic layers against lower kinetic energy debris cloud particles.

a. Outer Ballistic Layers

In an aspect, the outer ballistic layers are configured to break up an incoming projectile upon impact into smaller fragments, to change the phase of the projectile and/or fragments from a solid phase into a liquid (molten) phase and/or plasma phase, and any combination thereof. In addition, the materials of the ballistic layers, in particular the outer ballistic layers, may resist spalling and/or may readily convert to a plasma phase, thereby limiting the kinetic energy of any debris ejecta formed during the impact of a projectile with a ballistic layer. To this end, the materials used to construct the outer ballistic layers may be selected based on one or more of at least several desired characteristics, including but not limited to: light weight, high yield stress, high hardness, and high Young's modulus. In addition, because all ballistic layers may function as radiant barrier layers in conjunction with the IMLI sub-assemblies, the materials of the ballistic layers may be selected based on one or more additional thermal characteristics, including, but not limited to, low thermal conductivity and low thermal emissivity. Alternatively, the outer ballistic layer may be high density, whereas other layers and the overall structure may be low density.

Non-limiting examples of materials suitable for the outer ballistic layers include: ceramic cloths such as NEXTEL; fiberglass; aluminum plating; ceramic panels; ballistic armor panels, and other laminate armor materials comprising layers of metal, ceramic, and/or plastic materials. In addition, the outer ballistic layer materials may include energy-absorbing materials, including but not limited to KEVLAR and SPECTRA fiber.

The outer ballistic layers may be of any thickness depending on one or more of at least several factors including, but not limited to, the properties of the materials within the ballistic layer, the position of the ballistic layer within the MMOD/IMLI structure, the spacing of layers, the total number of layers in the MMOD/IMLI structure, the desired performance of the MMOD/IMLI structure, the desired weight of the MMOD/IMLI structure, and any combination thereof. In one aspect, if the outer ballistic layer is a NEXTEL layer, the thickness of the outer ballistic layer may range from about 0.25 mm to about 6.0 mm.

Each outer ballistic layer may include a single layer of a single material, or each outer ballistic layer may include two or more layers of a single material or multiple materials. The materials may either be situated immediately adjacent to one another, or the materials may be bonded into a single sheet with no space between the two or more attached layers. For example, an outer ballistic layer may include a NEXTEL sheet immediately adjacent to a KEVLAR sheet.

In another aspect, the materials of the outer ballistic layers may be modified to enhance the performance of these layers. For example, the materials of the outer ballistic layers may be metalized to reduce their thermal emissivity. Additionally, the various layers and/or spacers may be metalized such that the structure may provide electrical grounding, electromagnetic interference (EMI) shielding, shielding from static electricity, and the like, improving over conventional grounding techniques that involve a bolt which may both reduce thermal performance through high thermal conduction, and compromise the structure's MMOD shielding effectiveness by spalling when impacted by a projectile.

b. Inner Ballistic Layers

In an aspect, the inner ballistic layers are configured to absorb the energy of impinging debris clouds and ejecta generated by the multiple impacts of the projectile and subsequent primary, secondary, and subsequent debris clouds and ejecta with the ballistic layers and/or IMLI sub-assemblies situated above the inner ballistic layers. To this end, the materials used to construct the inner ballistic layers may be selected based on one or more of at least several desired characteristics, including but not limited to: light weight, high yield stress, lower Young's modulus relative to the materials of the outer ballistic layers, and any combination thereof. In addition, the materials of the inner ballistic layers may be selected based on one or more additional thermal characteristics, including, but not limited to, low thermal conductivity and low thermal emissivity.

Non-limiting examples of materials suitable for the inner ballistic layers include: cloths of aramid fibers such as KEVLAR, SPECTRA fiber, and TECHNORA. In addition, the inner ballistic layer materials may include any of the outer ballistic layer materials described herein above.

The inner ballistic layers may be of any thickness depending on one or more of at least several factors including, but not limited to, the properties of the materials within the ballistic layer, the position of the layer within the MMOD/IMLI structure, the spacing of layers, the total number of layers in the MMOD/IMLI structure, the desired performance of the MMOD/IMLI structure, the desired weight of the MMOD/IMLI structure, and any combination thereof. In one aspect, if the inner ballistic layer is a KEVLAR layer, the thickness of the inner ballistic layer may range from about 0.25 mm to about 6.0 mm.

Each inner ballistic layer may include a single layer of a single material, or each inner ballistic layer may include two or more layers of a single material or multiple materials. The layers may be situated immediately adjacent to each other, or the layers may be bonded into a single sheet with no space between the two or more attached layers. For example, an inner ballistic layer may include a NEXTEL sheet and a KEVLAR sheet.

In another aspect, the materials of the inner ballistic layers may be modified to enhance the performance of these layers. For example, the materials of the inner ballistic layers may be metalized to reduce their thermal emissivity or provide for an electrically grounded MMOD/IMLI structure.

### II. IMLI Sub-Assemblies

In an aspect, the MMOD/IMLI structure incorporates the discrete spacer design and the insulation structures of the Integrated Multilayer Insulation (IMLI) and Load Responsive Integrated Multilayer Insulation (LRMLI) disclosed in U.S. Pat. No. 7,954,301, Published U.S. patent application Ser. No. 12/493,852 (CIP), and Published PCT application PCT/US/2010/039352, all of which are hereby incorporated by reference in their entirety.

The thermal performance of the MMOD/IMLI structure is enhanced by the inclusion of one or more IMLI sub-assemblies including one or more low emissivity thermal radiant barrier layers separated by a plurality of spacers. The spacers may provide a controlled separation between the thermal radiant barrier layers to prevent thermal shorting, while also reducing the thermal conduction from layer to layer. The IMLI sub-assembly may be designed such that the insulation performance is relatively unaffected by compression effects due to gravity. As a result, the low-gravity performance of the IMLI sub-assembly may be better predicted from ground testing, and the regular gravity and low gravity performance of the IMLI sub-assembly may be more consistent and less sensitive to labor and assembly variations. The use of the spacers to support the thermal radiant barrier layers may also facilitate the automation of the IMLI sub-assembly fabrication and handling.

Referring again to FIG. 1, the MMOD/IMLI structure 100 may include the one or more IMLI sub-assemblies 102A and 102B. The IMLI sub-assembly 102A may include one or more thermal radiant barrier layers 106A-106E separated and supported by spacers 108C-108G and 108P-108T. The number of layers, layer thickness and materials used to construct the thermal radiant barrier layers 106A-106E may vary depending on the desired thermal performance of the IMLI sub-assembly 102A. In an aspect, the number of thermal radiant barrier layers may range from about 2 layers to about 1200 layers.

In addition, the number of IMLI sub-assemblies 102A and 102B may vary depending on the desired performance of the MMOD-IMLI structure 100 as well as the number of layers in each IMLI sub-assembly. In an aspect, the number of IMLI sub-assemblies incorporated into an MMOD/IMLI structure 100 may range from about 1 to about 10 or more sub-assemblies, resulting in a total number of thermal radiant barrier layers within the ranges described herein above. The number of IMLI sub-assemblies included in the MMOD/IMLI structure 100 may also be affected by the number of intervening ballistic layers 104C.

The IMLI sub-assemblies incorporated into an MMOD/IMLI structure may be identical to each other in design, or may vary in design between individual IMLI sub-assemblies. For example, design elements including, but not limited to the number of layers, the layer thickness and constituent material of the thermal radiant barrier layers, the spacing between adjacent thermal radiant barrier layers, the arrangement of spacers such as the arrangement of spacers within each level or the offset of support arrangements between successive levels, the intervening ballistic layers, and any combination thereof may vary between individual IMLI sub-assemblies incorporated into an MMOD/IMLI structure.

In another aspect, the sequencing of the one or more IMLI sub-assemblies incorporated into a MMOD/IMLI structure may further vary depending upon the desired performance of the MMOD/IMLI structure. For example, the MMOD/IMLI structure may include one or more single IMLI sub-assemblies alternating with one or more ballistic layers. In another example, the MMOD/IMLI structure may include a layer of IMLI sub-assemblies that include two or more consecutive IMLI sub-assemblies alternating with one or more ballistic layers.

a. Thermal Radiant Barrier Layer Materials

The thermal radiant barrier layers comprise thin sheets of material designed to inhibit the thermal radiation flux from/to the equipment situated beneath the MMOD/IMLI structure. The materials used to form the thermal radiant barrier layers are selected based on one or more of at least several factors including, but not limited to: light weight, low thermal conductance, low emissivity, resistance to damage during fabrication, transport, and subsequent use, and any combination thereof. Non-limiting examples of materials suitable for use as thermal radiant barrier layers include metalized polymers with a low emissivity surface, such as silverized, goldized, and/or aluminized MYLAR (polyethylene terephthalate polyester film) or KAPTON (polyimide film); polymers with a non-metallic coating such as vanadium oxide; layers with associated quantum dots; thin, low emissivity metal foils such as aluminum foil or tungsten foil; and any combination thereof.

b. Thermal Radiant Barrier Layer Thickness

The thickness of each thermal radiant barrier layer may be selected based on any one or more of at least several factors including, but not limited to: material used to construct the thermal radiant barrier layer; light weight; reduction of thermal conduction pathways within the MMOD/IMLI structure; reduction of layer emissivity; resistance to tearing; location within the IMLI sub-assembly; and any combination thereof. In addition, any one or more of at least several factors related to MMOD protection may be used to select the thickness of the thermal radiant barrier layer, including but not limited the ultimate stress and/or energy absorbing abilities of the layer's material.

The thickness of each thermal radiant barrier layer may range from about 0.1 mils to about 20 mils. In an aspect, the IMLI sub-assembly may include a bottom (innermost) layer that may comprise a sheet of metal or polymer ranging from about 1 mil to about 20 mils in thickness to provide a relatively sturdy structural base for the IMLI sub-assembly. This structural base may be situated directly against the surface of the underlying equipment to be protected in one aspect. In another aspect, this structural base may be situated exterior to the equipment such that the MMOD/IMLI structure does not directly contact the equipment. In addition, a layer of spacers may be attached to the base layer. In another aspect, the interior layers of the IMLI sub-assembly may range from about 0.1 mils to about 5 mils in thickness. In yet another aspect, the IMLI sub-assembly may include a top (outermost) layer ranging from about 1 mil to about 20 mils in thickness.

c. Separation Distance Between Adjacent Barrier Layers

The separation distance between adjacent thermal radiant barrier layers may influence the thermal performance of the IMLI sub-assemblies as well as other characteristics including but not limited to weight and structural integrity. In one aspect, the separation distance between adjacent thermal radiant barrier layers may range from about 40 mils to about 80 mils (i.e. about 1 mm to about 2 mm). In another aspect, the thermal radiant barrier layers may have a layer spacing of about 10 layers per cm. The separation distance between adjacent thermal radiant barrier layers may be governed by the height of the spacers situated between the adjacent layers of the IMLI sub-assembly.

### III. Spacers

In an aspect, the MMOD/IMLI structure includes a plurality of spacers situated between adjacent layers within the MMOD/IMLI structure including, but not limited to, between adjacent thermal radiation barrier layers within each IMLI sub-assembly, between a ballistic layer and an adjacent IMLI sub-assembly, between adjacent ballistic layers, and between an IMLI sub-assembly and a surface of the underlying equipment to be protected by the MMOD/IMLI structure. The spacers may support the layers and maintain a space or separation distance between adjacent layers within the MMOD/IMLI structure. Various aspects of the spacer pattern including, but not limited to, the number, distance between adjacent spacers within the same layer, and the spatial arrangement of the spacers may influence one or more characteristics of the MMOD/IMLI structure. Non-limiting examples of MMOD/IMLI structural characteristics that may be influenced by the spacer pattern include structural support of the layers within the MMOD/IMLI structure, controlled and repeatable inter-layer spacing, reduction of thermal conduction pathways, light weight, and overall structural integrity. In addition, the incorporation of discrete spacers made of a light weight material significantly reduces the vulnerability of the spacers to fragmentation and formation of high-velocity or high density debris ejecta relative to existing MMOD shield designs that include more substantial and massive rigid metal standoffs to maintain the separation of shield layers.

a. Attachment of Spacers to Layers of MMOD/IMLI Structure

In an aspect, each spacer may be attached to the adjacent layers situated above and below the spacer. In another aspect, each spacer may be attached to one of the adjacent layers situated either above or below the spacer. Referring back to FIG. 1, a spacer 108B may be attached to the adjacent ballistic layer 104B situated above the spacer, and to the adjacent thermal radiative barrier layer 106A situated below the spacer 108B. The attachment of spacers to all adjacent layers of the MMOD/IMLI structure and to the underlying equipment surface results in a robust integrated structure. Non-limiting methods of attaching each of the spacers to an adjacent layer include adhesive bonding, welding, mechanical attachment, molecular bonding, and any combination thereof. Non-limiting examples of adhesives suitable for use in adhesive bonding of the spacers to the adjacent layers include polyurethane adhesive, epoxy adhesive, pressure sensitive adhesives, electrically conductive adhesives, and any combination thereof.

In another aspect, each of the spacers may be securely attached to the exposed upper and lower surfaces of the corresponding adjacent layers situated immediately above and below each spacer without perforating or otherwise penetrating the material of the corresponding adjacent layers. In this aspect, each layer remains intact, with no discontinuities in the material, which may degrade the bi-directional thermal management of the MMOD/IMLI structure due to the transmission of thermal radiation through the discontinuities in the material of the layer.

b. Arrangement of Spacers within MMOD/IMLI Structure

The spacers may be arranged in any spatial arrangement that results in acceptable structural integrity, thermal performance, and MMOD protection for the MMOD/IMLI structure. In an aspect, the spacers within a layer may be arranged in a grid pattern, with vertical alignment of the corresponding spacers within layers above and below each spacer in the grid, as illustrated in FIG. 1. In this aspect, the spacers may be interconnected by means of the intervening layers; for example spacers 108G and 108H may be interconnected by a mutual attachment to the ballistic layer 104C as shown in FIG. 1. Because the material of the layers is not perforated or otherwise altered, the integrity of the layers is maintained in this aspect. In another aspect, the stacked spacers may be interconnected to one another to form a continuous spacer structure. Non-limiting methods or devices for interconnecting the stacked spacers include mechanical attachments, fasteners, magnets, molecular or electrical bonding, solvent bonding, adhesives, polymer welding, and any combination thereof.

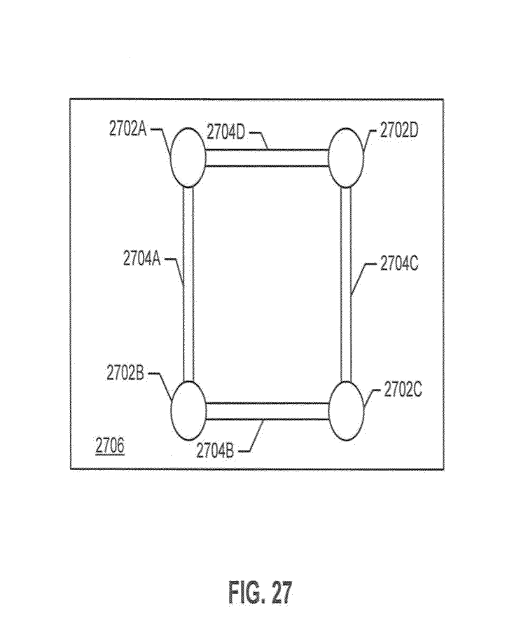

In an aspect, each spacer within a layer may be interconnected to one or more adjacent spacers by beams or webbing attached to each of the interconnected spacers, as illustrated in FIG. 27. In this aspect, the spacers 2702A-2702D may be interconnected by beams 2704A-2704D. For example, spacer 2702A may be held at a fixed distance from neighboring spacers 2702B and 2702D by beams 2704A and 2704D; beam 2704A is attached at each end to spacers 2702A and 2702B, and beam 2704D is attached at each end to spacers 2702A and 2702D. The beams 2704A-2704D may maintain the spacing of spacers 2702A-2702D in a fixed pattern. In an aspect, the spacers interconnected by beams need not be attached to an adjacent layer 2706 to maintain the fixed grid pattern.

The interconnecting webbing or beams may be fabricated from the same material as the spacers as described herein below in one aspect. In another aspect, the interconnecting beams or webbing may be provided as part of an integrated spacer/webbing support structure situated between the adjacent layers of the MMOD/IMLI structure. In yet another aspect, the interconnecting webbing or beams may be fabricated from different material than the spacers. In this aspect, any of the suitable spacer materials described herein below may be used.

The beams or webbing may enhance the ease of handling and alignment of the spacers during assembly, and may further reinforce the buckling strength of the spacers. The beams may be arranged to connect all the spacers in a layer in a two-dimensional grid in one aspect. In another aspect, the beams may be arranged so there are gaps in the two-dimensional grid pattern to reduce the overall mass of the grid layer, to provide flexibility to the MMOD/IMLI structure, and to provide regions through which the MMOD-IMLI structure may be more easily cut. Other arrangements or combinations of beams and spacers are possible.

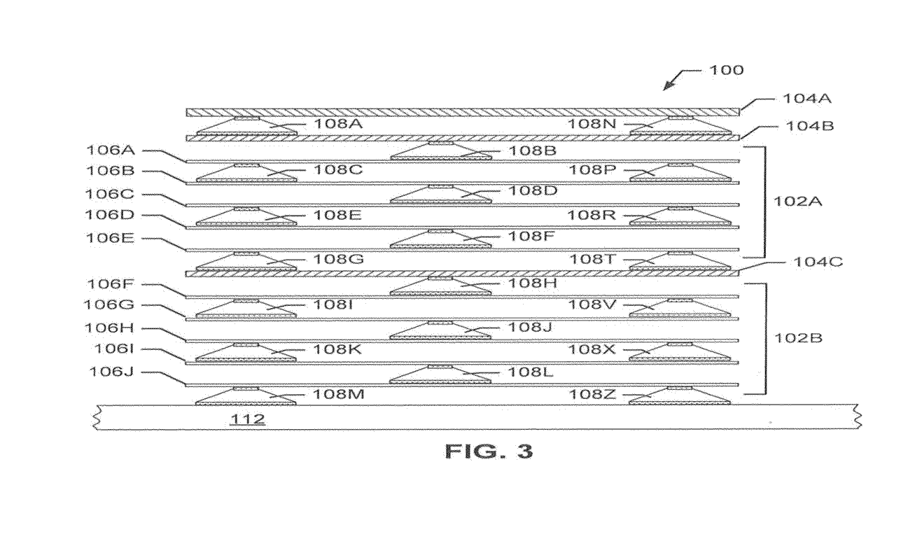

In an additional aspect, the spacers may be arranged in a grid pattern with staggering of the patterns between adjacent layers, as illustrated in FIG. 3. This staggered arrangement of spacers results in the elongation of conductive thermal pathways formed by the stacked spacers in the aligned grid pattern illustrated in FIG. 1. Referring back to FIG. 3, the only conductive pathway between spacers on adjoining levels is through the material of an intervening layer similar to FIG. 1. However, a thermal conductive pathway between spacers 108G and 108F by necessity must further include the intervening transverse thermal radiative barrier layer 106E extending between spacers. Thermal conduction to or from the underlying equipment through the MMOD/IMLI structure is inhibited by the imposition of the intervening layers with relatively low thermal conductivity into the conductive pathways. As a result, the thermal performance of an MMOD/IMLI structure may be enhanced by the inclusion of a staggered spacer pattern.

In another additional aspect, the spacers may be designed such that the conductive thermal pathway between vertically-aligned spacers within adjacent layers is disrupted independent of the degree of vertical alignment of the grids of spacers on between adjoining levels. A detailed description of aspects of the spacer design is presented in more detail herein below.

c. Spacer Materials

In an aspect, the spacers may be fabricated from a molded polymer with low thermal conductivity, high compressive strength and hardness and low vacuum outgassing. Non-limiting examples of suitable molded polymers include polyetherimide, polyimide, polyamide-imide, polyethyl ketone or wholly aromatic copolyesters. Other examples of suitable spacer materials include high-temperature spacer materials such as alumina or ceramic materials. For example, the spacers may be formed from ULTEM (polyetherimide) or PEEK (polyetheretherketone). The upper and lower surfaces of a spacer that contact adjacent layers may include a rough surface texture, including, but not limited to grooves, to minimize the contact conductance between the spacer and the adjacent layer and/or the vertically aligned and adjacent spacers.

In another aspect, a thin layer of aluminum, gold, silver or other low-emissivity material may be deposited on the surface of the spacers to reduce the infrared absorption of the metalized spacer as compared to an un-metalized spacer. The metalized spacers may further function as conductive elements in an electrically grounded MMOD/IMLI structure in an aspect.

Reducing the infrared absorption of the spacers through metalizing the spacer surface may enhance the thermal insulation performance of the MMOD/IMLI structure in one aspect. In another aspect, the spacer material may be coated with any metallic or non-metallic material having a suitably low emissivity. The metalizing of the spacer surface may comprise the formation or provision of a metal layer that covers all or substantially the entire exposed surface of the spacers. As used herein, substantially the entire exposed surface of a spacer comprises at least most of the surface of the spacer that is not adhered to or in contact with an adjacent layer. The metalizing of the spacer surface may be patterned, such that gaps are formed in the metal layer, thereby disrupting the thermal conductive path along the metalized surface of the spacers. The inclusion of these gaps may ameliorate any degradation in the insulation performance of the MMOD/IMLI structure due to thermal conduction paths along the metal layers on the spacers. The metal layer may be deposited on the spacer using any existing method, including but not limited to vapor deposition, electroplating or any other known metal deposition technique. Gaps in the metal layer may be formed by masking the spacers during metal deposition or by removing portions of the metal layer by etching or mechanical processes.

d. Spacer Design

The design of the spacer may be based on any one or more of at least several criteria including, but not limited to: structural strength, maintenance of constant and reliable distance between adjacent sheets, light weight, low thermal conductivity, low thermal emissivity, compatibility with layer materials and methods of attaching the spacers to the layer materials, and any combination thereof. Various aspects of the spacer design were previously provided herein above.

In an aspect, the spacer design may also incorporate compressible elements to facilitate the compressing of the MMOD/IMLI structure into a compressed state for transport and installation at any stage of mission preparation or at any stage of the mission itself, and to further implement the reversion of the MMOD/IMLI structure prior to use or once on orbit. In these aspects, the spacer may incorporate flexible, resilient elements sized and dimensioned to provide the desired degree of compressibility without compromising the integrity of the MMOD/IMLI structure in use. Any spacer design that incorporates compressible elements may be used in the MMOD/IMLI structure, including any of the spacer designs of the Integrated Multilayer Insulation (IMLI) and Load Responsive Integrated Multilayer Insulation (LRMLI) disclosed in U.S. Pat. No. 7,954,301, Published US patent application Ser. No. 12/493,852 (CIP), and Published PCT application PCT/US/2010/039352, all of which are hereby incorporated by reference in their entirety.

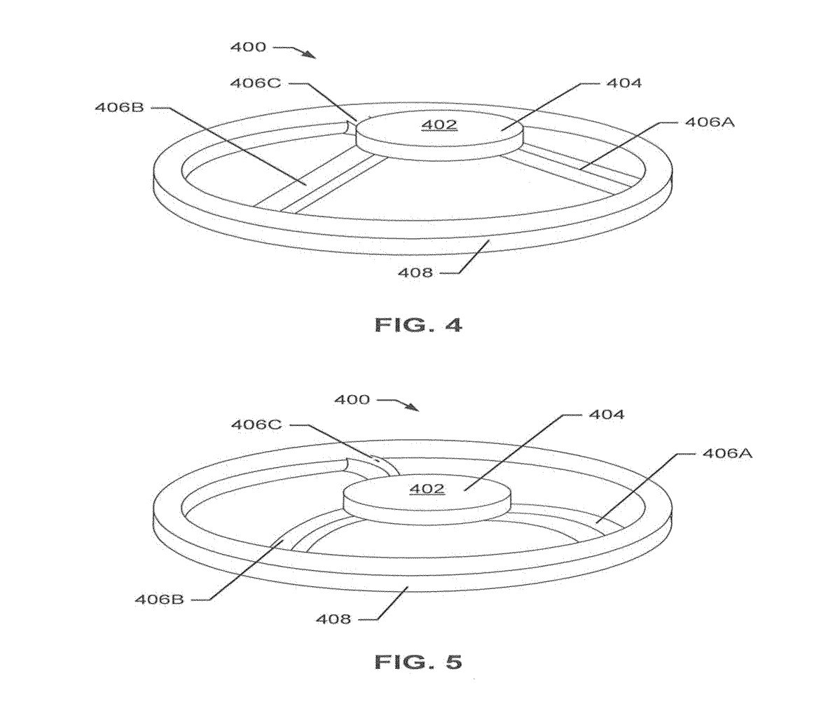

FIG. 4 illustrates a spacer 400 in one aspect. The spacer 400 includes a top surface 402 formed by a top structure 404. Extending from the top structure 404 are three support arms 406A-406C. The support arms 406A-406C terminate at a base structure 408. The base structure 408 may comprise an annular structure to which each of the support arms 406A-406C is connected. Alternatively, the base structure 408 may assume other forms including, but not limited to, triangular, polygonal, and semi-circular forms. In an aspect, the base structure 408 may be omitted from the spacer 400. It is to be noted that the terms “top” and “base” are used for convenience of description, but are not to be construed as limiting as to the orientation of the spacer 400. For example, a MMOD/IMLI structure may be oriented in any direction, and the top structure 404 and the base structure 408 within the MMOD/IMLI structure may be oriented such that, at least from the perspective of a viewer, the base structure 408 is above, below, or at the same elevation as the top structure 404. In an aspect, the height of the spacers, defined as the distance between the top surface 402 and the bottom surface of the base structure 408 may range from about 40 mils to about 80 mils in an uncompressed condition. In another aspect, the maximum diameter of the spacers may range from about 40 mils and about 500 mils.

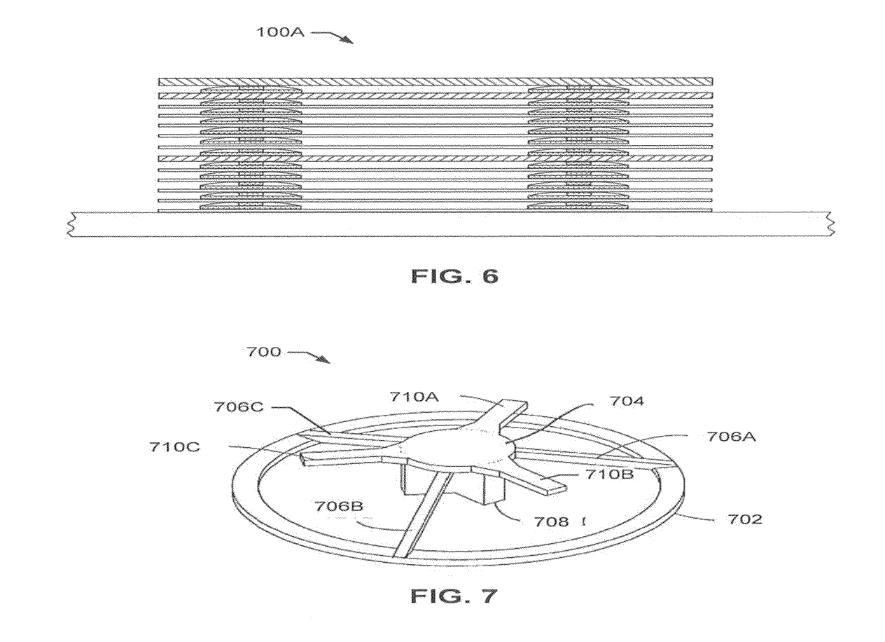

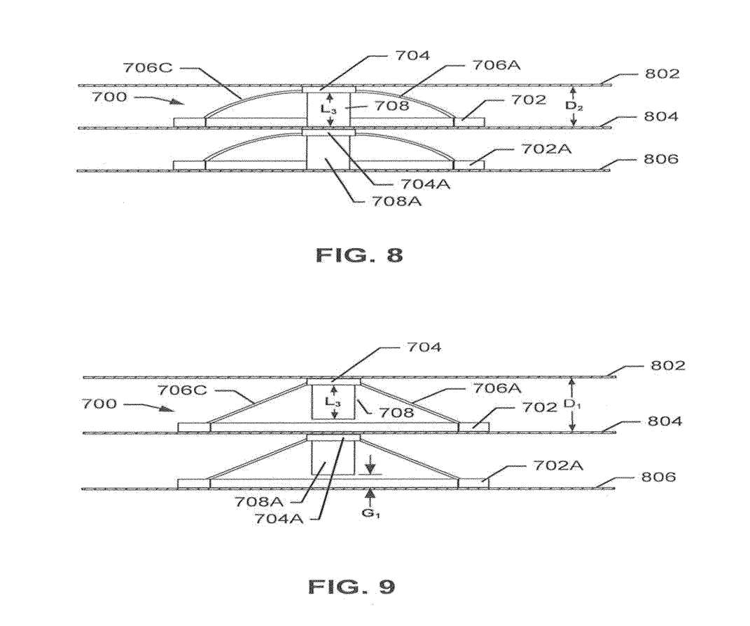

In an aspect, the spacers 400 may be designed to reversibly compress under loading for reduction in volume during mission preparation and during various stages of the mission, and to self-deploy as needed during mission preparation and during various stages of the mission. For example, the spacer 400 may be constructed from a resilient material such that the support arms 406A-406C may deform under a compressive load, as illustrated in FIG. 5. The predefined resiliency of the spacers 400 in this aspect may allow the MMOD/IMLI structure 100A to be compressed to a lower volume state and restrained, which would be maintained prior to and during launch, as illustrated in FIG. 6.

Once in orbit, a self-deployment feature may be actuated to remove the compressed state and allow the structure to return to its natural uncompressed state as illustrated in FIG. 1, thereby restoring the predefined interlayer spacing for both thermal management and MMOD protection.

Depending on the degree of compressing, the base structure 408 and top structure 404 of a particular spacer 400 may be situated in close proximity to the base structures and top structures of corresponding spacers situated immediately above and below the particular spacer 400, separated only by the intervening material of the layers above and below the particular spacer 400. This close proximity of the top structures and base structures forms a pathway having a significantly lower resistance to thermal conduction than exists when the MMOD/IMLI structure is in an uncompressed state. As a result, the thermal insulation performance of the MMOD/IMLI structure that includes spacers of the design illustrated in FIG. 4 may be degraded in the compressed state beyond the degradation attributable to the reduction in layer separation distances resulting from the compressing of the MMOD/IMLI structure.

To reduce the reduction in thermal insulation performance in the compressed state due to the creation of low-resistance thermally conductive pathways due to the close proximity of vertically adjacent spacers, a modified spacer design, illustrated in FIG. 7 may be incorporated into the MMOD/IMLI structure in another aspect. Referring to FIG. 7, the modified spacer 700 may be designed to reversibly compress through a specified range of movement between a minimum support height in a compressed state and a maximum support height in an uncompressed state.

The spacer 700 includes a base structure 702 and a top structure 704 connected by resilient support arms 706A-706C. Upper support arms 710A-710C project radially from the top structure 704, forming a stable tripod for contact with the layer immediately above the spacer 700. The upper support arms 710A-710C may be arranged in any alignment. For example the upper support arms 710A-710C may be aligned vertically with the resilient support arms 706A-706C. Alternatively, the upper support arms 710A-710C may be rotated with respect to the resilient support arms 706A-706C so that each upper support arm is situated between two adjacent resilient support arms, as illustrated in FIG. 7. The spacer 700 further includes a support beam 708 with a Y-shaped cross-section attached at one end to the underside of the top structure and extending downward from the top structure. The lobes of the support beam 708 may be aligned vertically with the upper support arms 710A-710C, as illustrated in FIG. 7.

The design features of the spacer 700 may result in enhanced support during compression of the spacer 700, as illustrated in FIG. 8. In compression, the resilient support arms 706A and 706C may deform to implement the vertical compression of the spacer 700 under compressive loading. The height L₃ of support beam 708 limits the compression of the spacer 700 resulting in a minimum layer separation distance D₂. Enhanced support is provided by the spacer 700 during compression due to the free end of the support beam 708 contacting the underlying layer 804. Further downward movement of the support beam 708 is resisted by the top structure 704A situated immediately below the support beam 708 on the opposite side of the intervening layer 804. However, due to the shape of the support beam 708 and upper support arms 710A-710C, heat conduction between top structure 704A and the support beam 708 is reduced due to the reduction of the contact area between vertically adjacent spacers.

When the spacer is in an uncompressed state, as shown in FIG. 9, the resilient support arms 706A and 706C resume an undeformed geometry, resulting in an increase of the layer separation distance to a maximum distance D₁. In the uncompressed state, the free end of the support beam 708 lifts away from the underlying layer 804, forming a gap with a designated gap height G₁; this gap may disrupt the thermal conduction pathway previously formed between the top structure 704A and the support beam 708 in the compressed state, thereby reducing the conductance of heat through the spacers 700.

In other aspects, the support beam 708 may incorporate additional cross-sectional shapes and/or orientations. For example, the support beam 708 may be a solid cylinder or an open (hollow) cylinder in an aspect.

### IV. Method of Producing MMOD/IMLI Structures

In an aspect, a method of producing an MMOD/IMLI structure is provided. This method includes attaching successive layers of thermal radiative barrier materials and/or ballistic materials in succession to build up the MMOD/IMLI structure. Referring back to FIG. 1, the fabrication of an MMOD/IMLI structure may begin by attaching a layer of spacers such as spacers 108M and 108Z to the underlying equipment surface 112 using an adhesive applied to the bottom surface of the spacers 108M and 108Z. In other aspects, the layer of spacers may be attached to a sheet of a material such as MYLAR surrounding the underlying equipment surface 112, or this layer of spacers may be omitted altogether.

Adhesive may then be applied to the top surface of the spacers 108M and 108Z, and the first thermal radiative barrier layer 106J may be placed on top of spacers 108M and 108Z, thereby attaching the first thermal radiative barrier layer 106J to the top surface of the spacers 108M and 108Z. In another aspect, a ballistic layer (not shown) may be attached or situated over the underlying equipment surface 112. The bottom surfaces of a second layer of spacers 108L and 108Y may then be attached to the upper surface of the first thermal radiative barrier layer 106J. Similarly, an adhesive may be applied to the top surfaces of spacers 108L and 108Y and the second thermal radiative barrier layer 1061 may then be attached to the top surfaces of spacers 108L and 108Y. In a similar manner, the spacers 108K and 108X may be attached to the second thermal radiative barrier layer 1061, followed by the attachment of the third thermal radiative barrier layer 106H to the top surfaces of spacers 108K and 108X and so on. Each array of spacers may be arranged in vertical alignment with the array of spacers in the previous layer, as illustrated in FIG. 1, or in an offset arrangement, as illustrated in FIG. 3. In another aspect, if the underlying equipment surface 112 is in a curved shape including, but not limited to, cylindrical or spherical shape, each array of spacers may be arranged in a radial pattern, in which the corresponding spacers in adjacent layers are aligned along a radius of the underlying equipment surface 112. Other arrangements of spacers are possible, depending on any number of factors including but not limited to the shape of the underlying equipment surface 112.

The layering process may be continued until the desired arrangement and number of layers in the MMOD/IMLI structure are achieved. Each of the layers may be securely attached to its corresponding adjacent layers, and the adjacent layers may be uniformly spaced relative to each other at a distance governed by the height of the spacers. Dispersed within the MMOD/IMLI structure are a number of radiation barrier layers as well as a number of ballistic layers in any order as needed.

In another aspect, the MMOD/IMLI structure may include at least one lateral edge defining the perimeter of the structure. In this aspect, the MMOD/IMLI structure may be assembled over the underlying equipment surface by seaming the adjoining lateral edges of adjacent modular panels together. The seaming of the adjoining lateral edges may be accomplished using any known joining technique including, but not limited to, sewing, bonding, taping, snapping, interleaving or by other means such that the seamed lateral edges form a continuous MMOD/IMLI structural surface capable of providing full thermal insulation and MMOD protection. In this aspect, the layers of one lateral edge may be overlapped and/or interleaved with the layers of the adjacent lateral edge of the seamed lateral edges. This aspect overcomes a limitation of previous panel designs, in that the joining of heavier, stiff existing panels such as Whipple Shields or Stuffed Whipple Shields results in a discontinuous abutment of panels that may either include small unprotected regions or overlapping regions that result in additional mass and an increased risk of debris generation due to spalling due to the impact of a projectile on an overlapping seam.

### EXAMPLES

The following examples illustrate various aspects of the present disclosure.

### Example 1

### Construction of Ballistic Coupons for Projectile Impact Testing

To demonstrate the feasibility of constructing an MMOD/IMLI structure as described herein above, the following experiments were conducted.

Ballistic coupons were assembled for use in Projectile Impact Testing. Each ballistic coupon included a total of 120 layers of material, including twelve ballistic layers and 108 layers associated with IMLI sub-assemblies. Each coupon included the IMLI sub-assemblies situated in between each of six inner KEVLAR ballistic layers and six outer NEXTEL ballistic layers. Neighboring individual layers were separated by ULTEM tripod spacers similar to the spacer illustrated in FIG. 4. The spacers were arranged in a grid pattern.

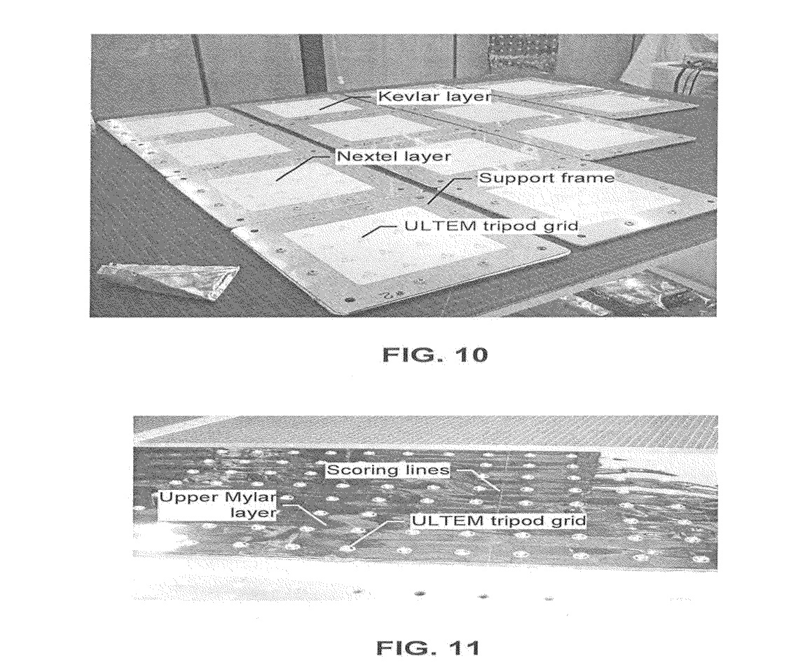

Each of the 12 ballistic layers were constructed by securing a layer of KEVLAR or NEXTEL within a stainless steel support frame for additional support during high-velocity impact (HVI) testing, as shown in FIG. 10. The support frames were sized for mounting on a light gas gun used to deliver the test projectiles to the coupons. The six NEXTEL ballistic layers were situated within the outer portion of the coupon and the six KEVLAR ballistic layers were situated within the inner portion of the coupon. ULTEM tripod spacers were bonded to the upper surface (i.e. the surface facing outward) of each ballistic layer as shown in FIG. 10.

Each of the IMLI sub-assemblies was constructed by layering 9 MYLAR sheets, and neighboring MYLAR sheets were separated at a fixed distance using ULTEM tripod spacers, as shown in FIG. 11. The ULTEM tripod spacers were spaced in a 2″×2″ grid pattern. The IMLI sub-assemblies were produced by cutting the sheet shown in FIG. 11 along the scoring lines to produce individual 8″×8″ sub-assemblies.

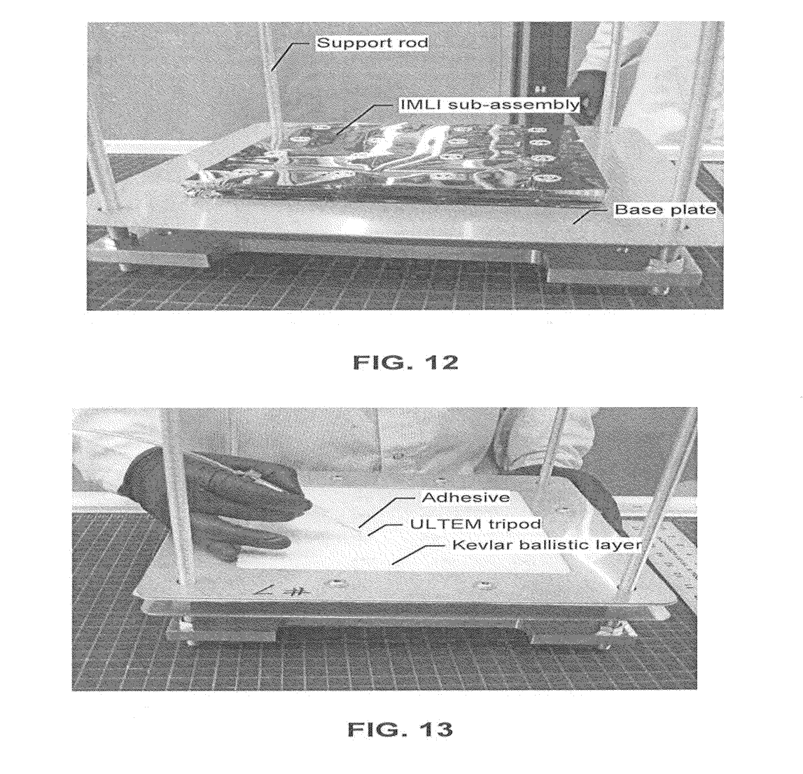

The coupon was assembled by alternating ballistic layers and IMLI sub-assemblies. Initially, the first IMLI sub-assembly was attached to a base plate as shown in FIG. 12. The base plate was held in place by four support rods, as shown in FIG. 12. After applying adhesive to the top of each of the ULTEM tripod spacers, the first KEVLAR ballistic layer was attached to the first IMLI sub-assembly as shown in FIG. 13. The KEVLAR ballistic layer was situated over the IMLI sub-assembly by passing the four support rods through corresponding holes in the ballistic layer's support frame. After applying adhesive to each of the ULTEM tripod spacers as shown in FIG. 13, the second IMLI sub-assembly was attached to upper surface of the first ballistic layer.

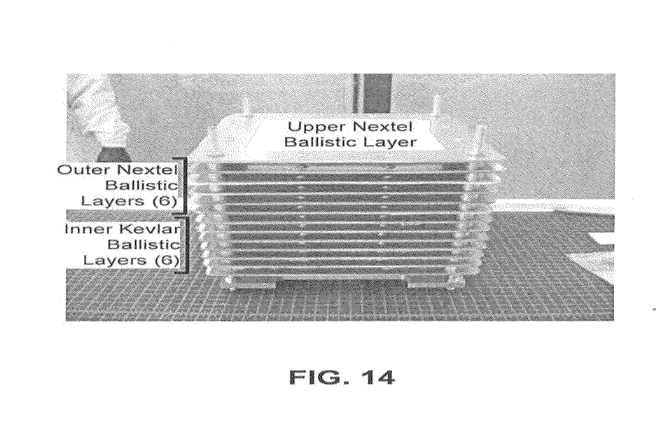

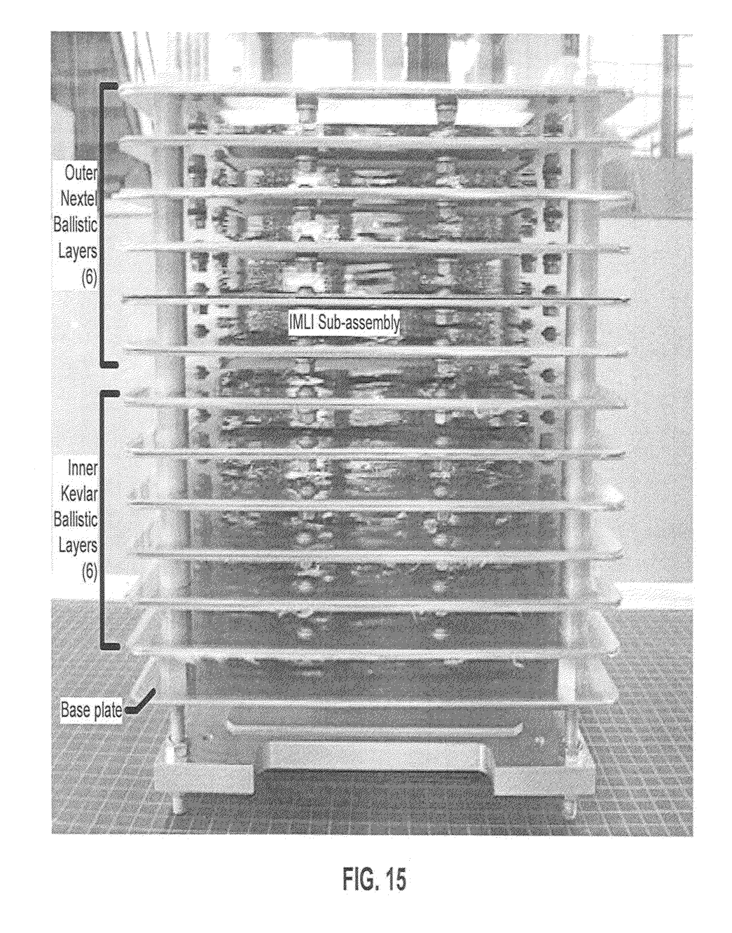

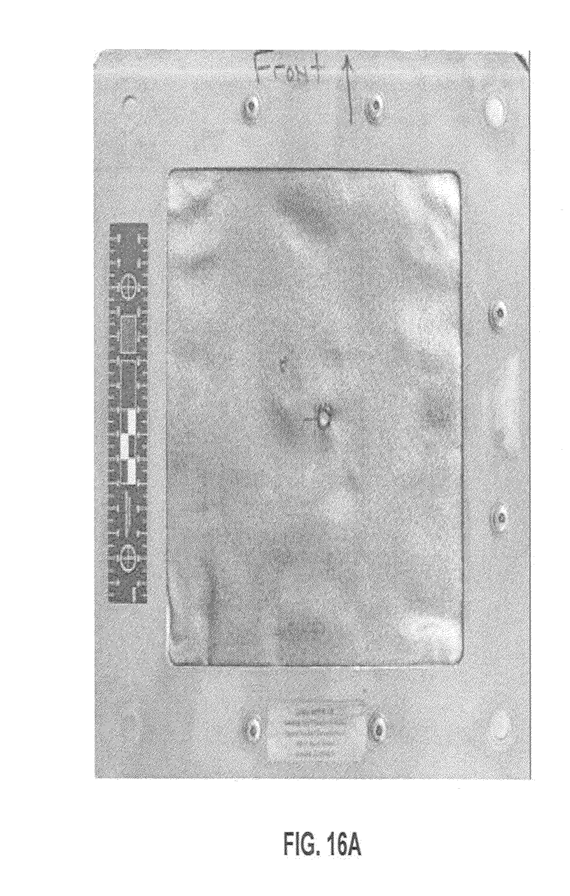

In a similar manner, the second KEVLAR sub-assembly was attached to the upper surface of the second IMLI sub-assembly, and so on until all six KEVLAR ballistic layers, followed by all six NEXTEL ballistic sublayers, each separated by an IMLI sub-assembly, were stacked and attached, as shown in FIG. 14. The final and uppermost layer of the coupon was the sixth NEXTEL layer. As shown in FIG. 15, the six NEXTEL ballistic layers were situated within the upper end of the coupon and the six KEVLAR ballistic layers were situated within the lower end of the coupon. Each ballistic layer was separated by an IMLI sub-assembly, also shown in FIG. 15.

The results of this experiment demonstrated the feasibility of assembling an MMOD/IMLI structure that included alternating ballistic layers and IMLI sub-assemblies.

### Example 2

### Projectile Impact Testing of Ballistic Coupons

To assess the ability of an MMOD/IMLI structure to withstand the impact of high velocity projectiles such as micrometeoroids or orbital debris, the following experiments were conducted.

The ballistic coupon described in Example 1 was mounted to a HVIT light gas gun (LGG) at the White Sands Test Facility (WSTF) in Las Cruces, N. Mex., USA. The test coupon was impacted by a 5.4 mm projectile traveling at a velocity of 6.63 km/s, as fired from the 0.50 cal LGG. The projectile was previously predicted to penetrate to the lowest KEVLAR ballistic layer, i.e. the 12^{th} ballistic layer counting from the outermost layer (analysis not included).

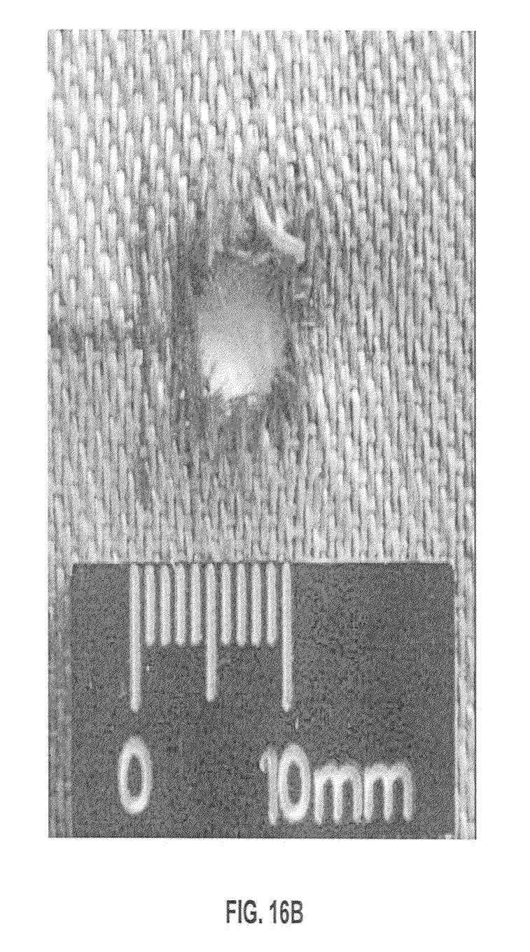

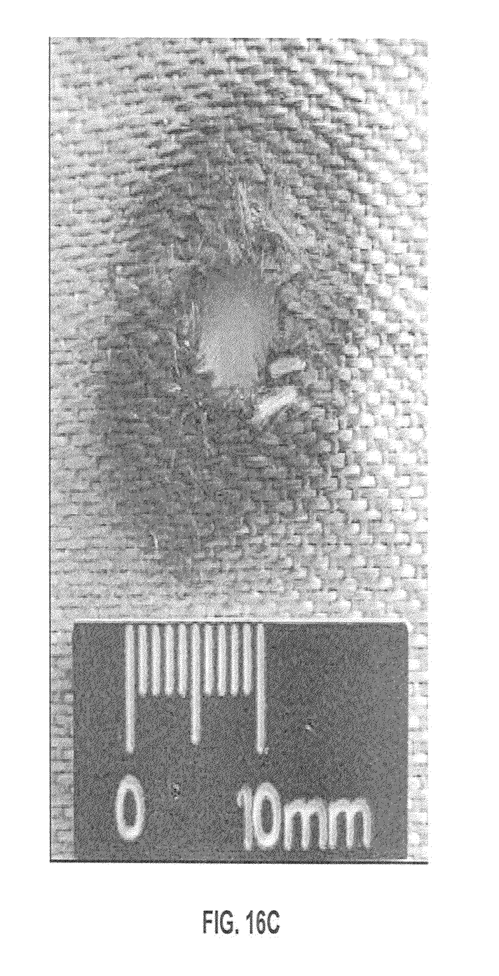

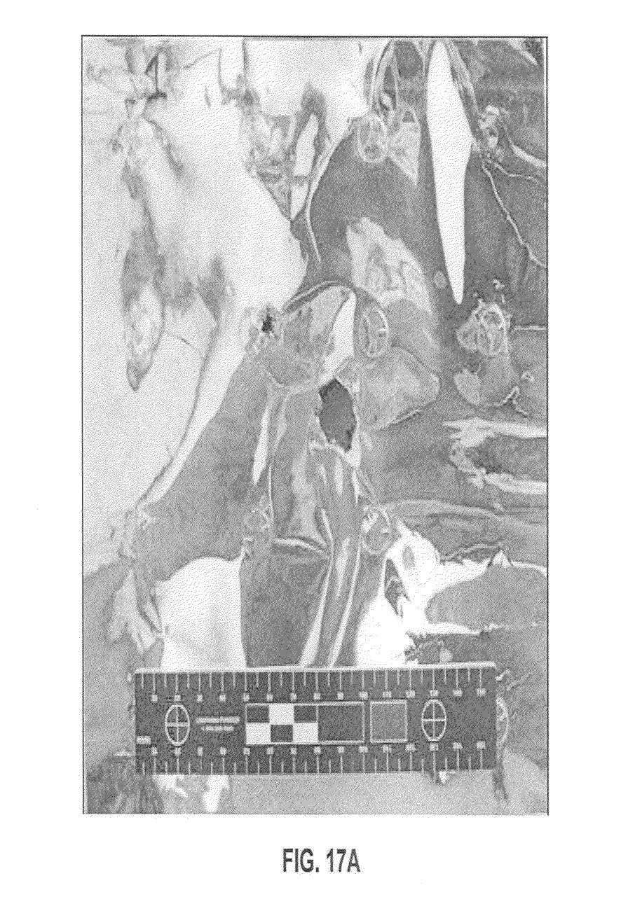

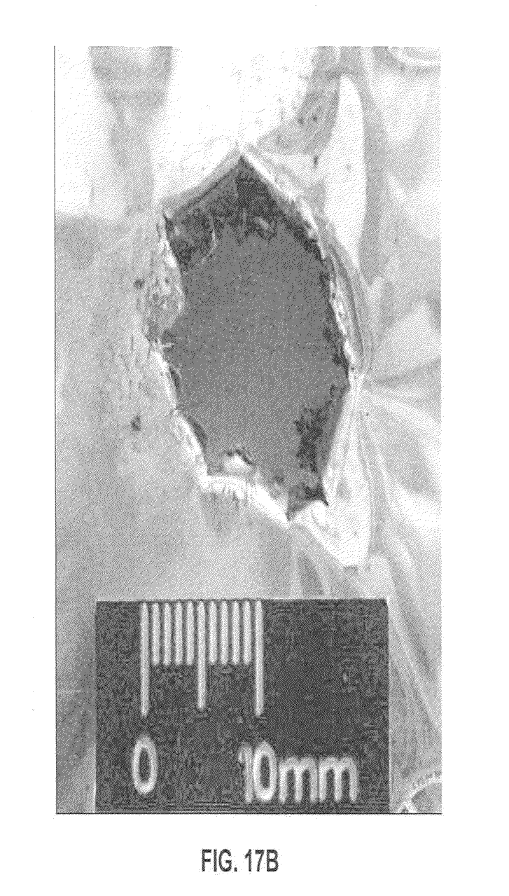

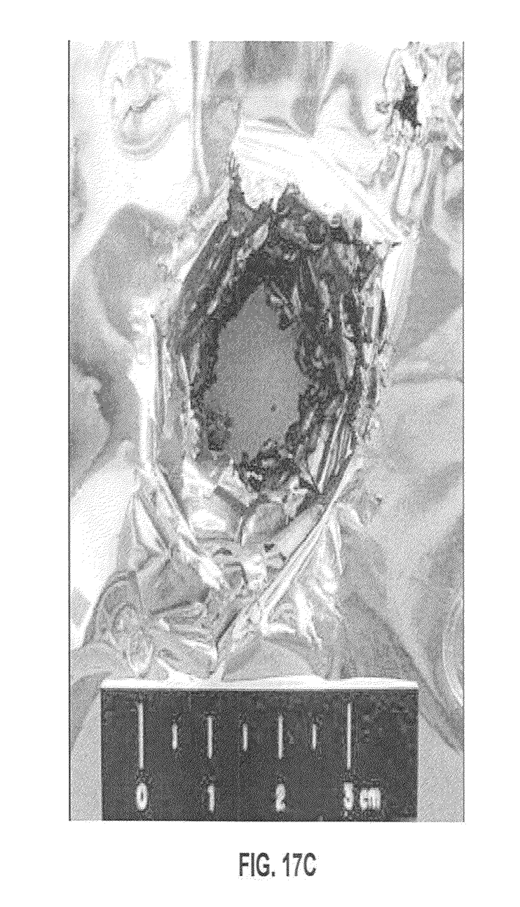

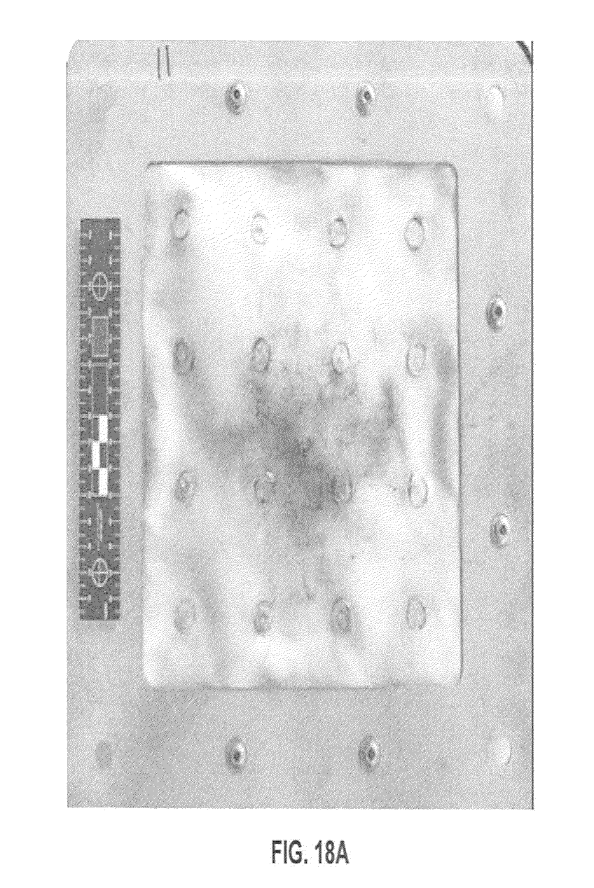

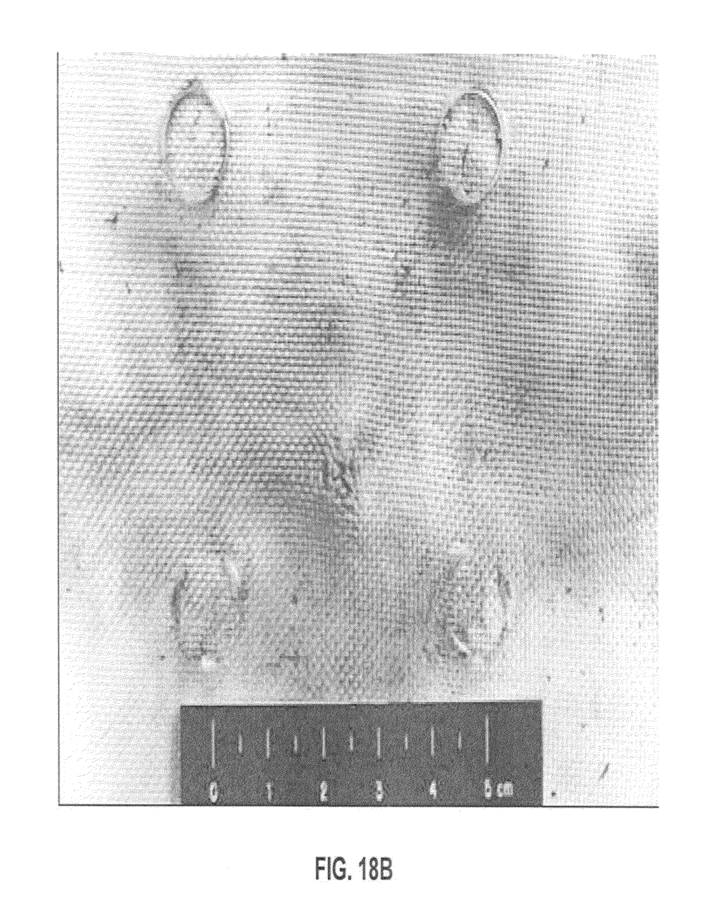

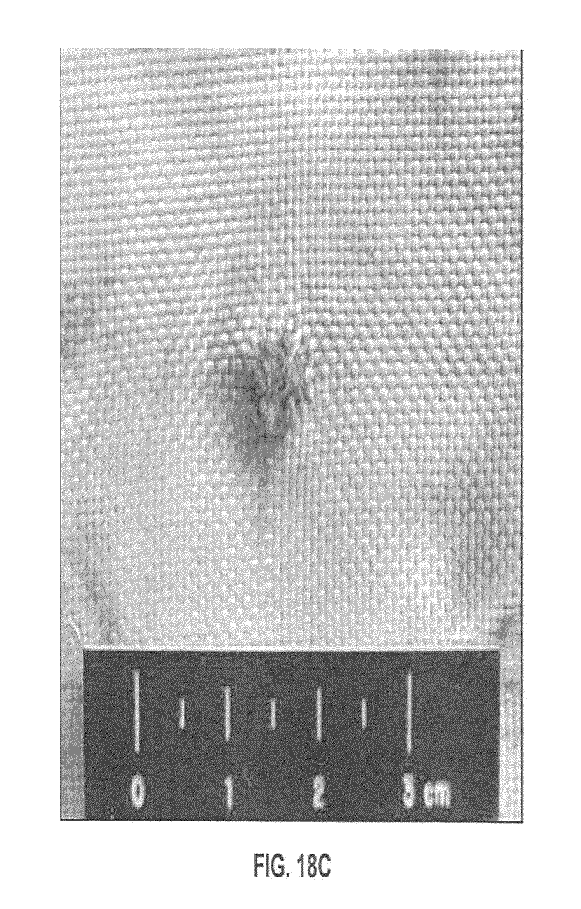

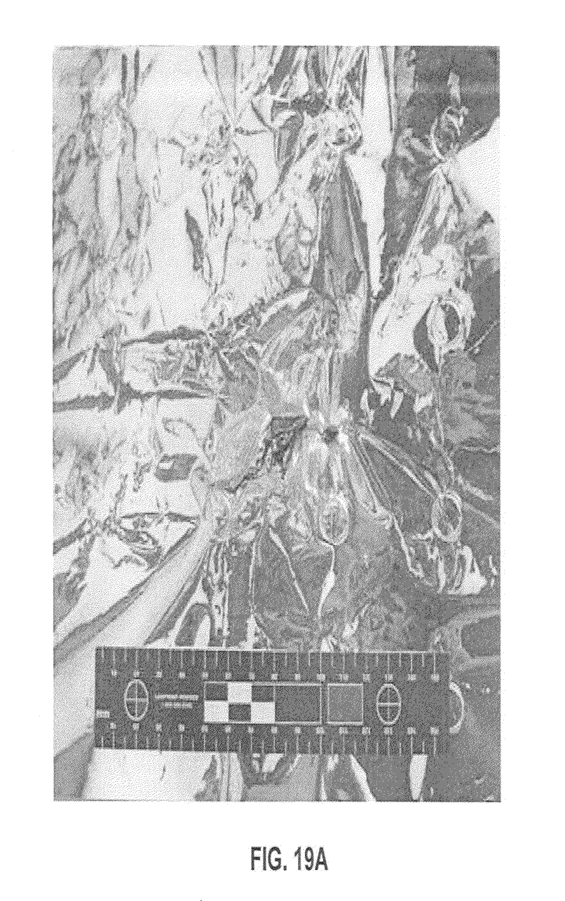

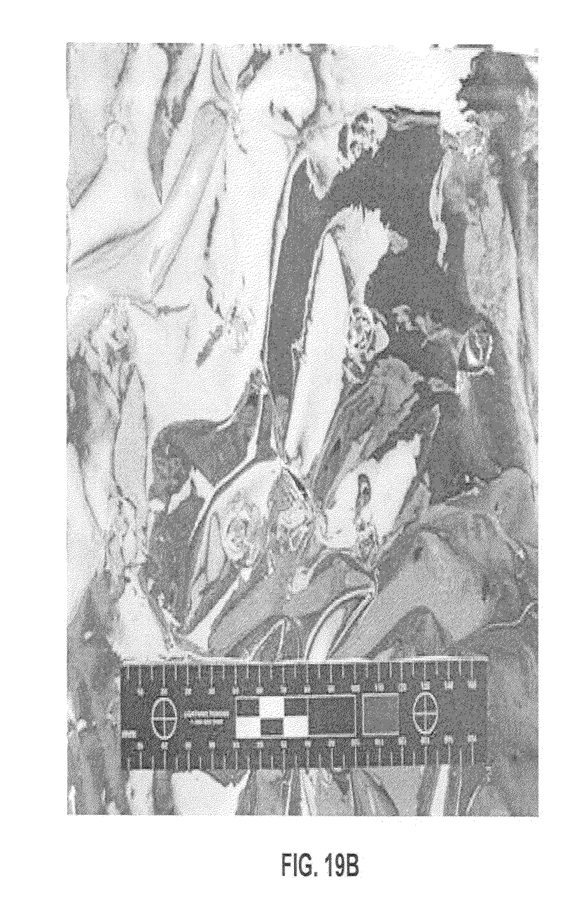

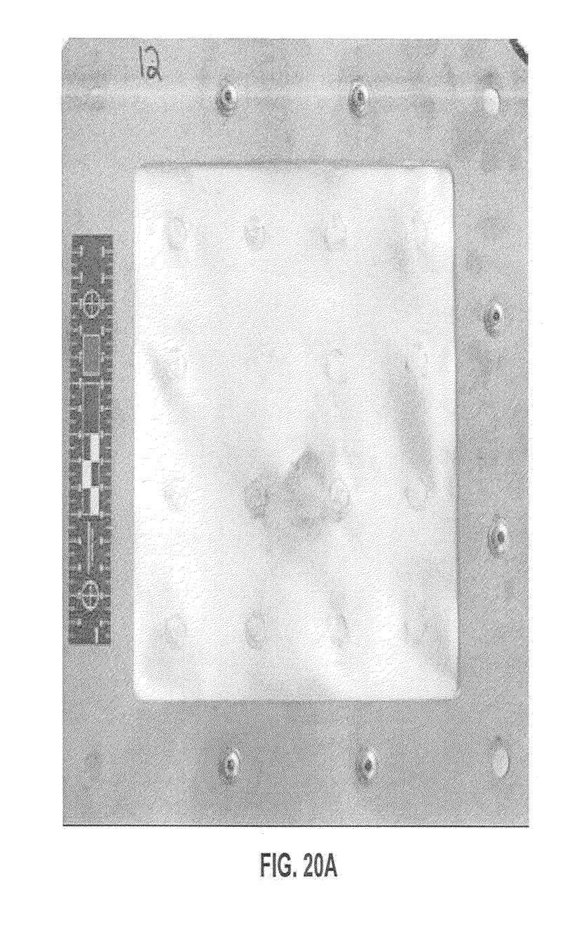

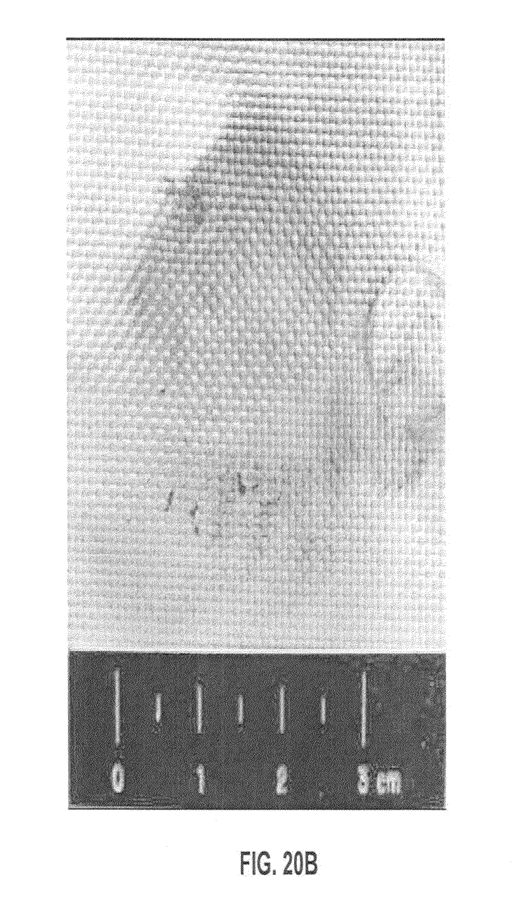

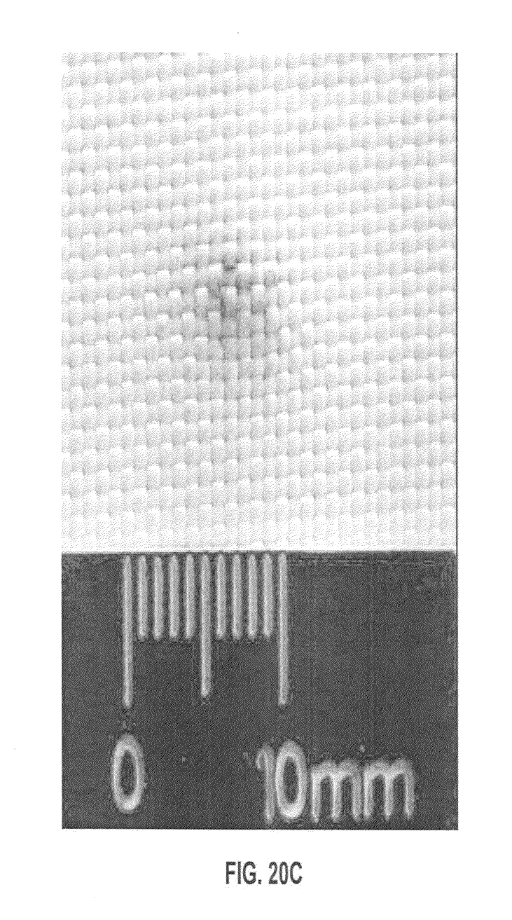

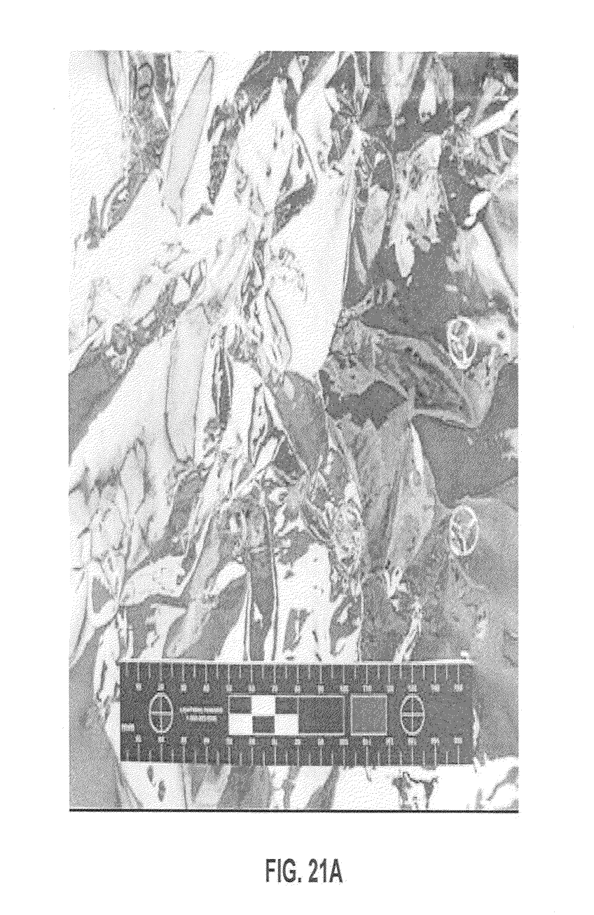

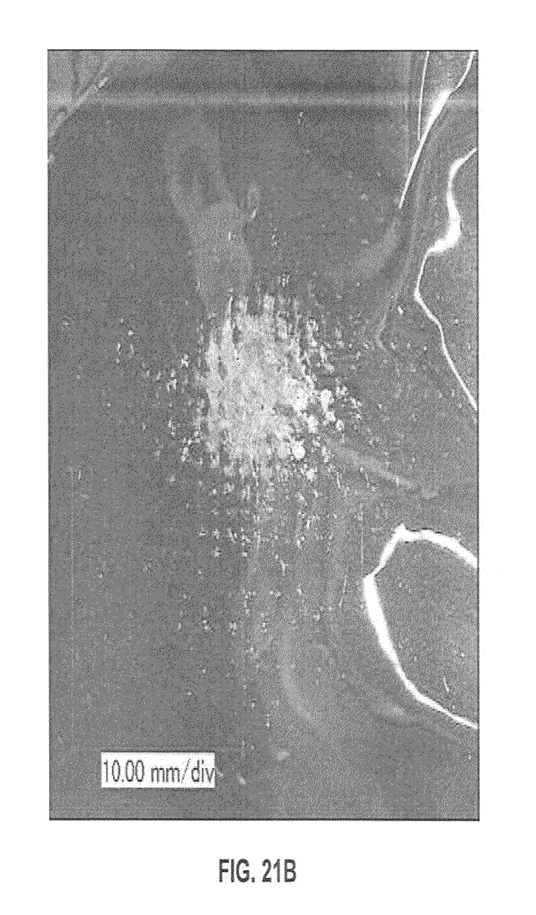

As summarized in FIGS. 16-21, the projectile penetrated to the 12th ballistic layer, corresponding to the last (innermost) KEVLAR layer. The projectile entered the upper surface of the first NEXTEL ballistic layer as shown in FIGS. 16A and 16B, and exited the lower surface as shown in FIG. 16C. The projectile then entered the upper surface of the first IMLI sub-assembly as shown in FIGS. 17A and 17B, and exited the lower surface as shown in FIG. 17C. Note that the projectile produced larger holes in the lower MYLAR layers compared to the upper MYLAR layers of the first IMLI sub-assembly, as shown in FIG. 17C, indicating an expanding debris cloud as previously described herein above. The entry of the projectile into the second NEXTEL ballistic layer is shown in FIGS. 18A and 18B, and the exit of the projectile from this layer is shown in FIG. 18C. The entry and exit of the projectile passing through IMLI sub-assembly layer #11, located above the 12^{th} ballistic layer, is shown in FIGS. 19A and 19B. The impact of the projectile onto the 12th ballistic layer, without penetration of the KEVLAR, is shown in FIGS. 20A and 20B, and the rear of this layer is shown in FIG. 20C. The upper surface of the bottom (12^{th}) IMLI sub-assembly is shown in FIGS. 21A and 21B. Particulates are visible on the surface of the 12^{th} IMLI sub-assembly in FIG. 21B, but no penetration occurred.

The results of this experiment demonstrated the ability of the MMOD/IMLI structure to withstand the impact of high velocity projectiles.

### Example 3

### Construction of an MMOD/IMLI Thermal Structure for Thermal Testing

To demonstrate the feasibility of constructing an MMOD/IMLI thermal test article suitable for thermal testing, the following experiments were conducted.

The thermal test article representing a subset of the ballistic coupon described in Examples 1 and 2 was designed and fabricated to allow small scale thermal performance testing. The resulting MMOD/IMLI thermal test article was sized to fit a 20 L test calorimeter. The MMOD/IMLI thermal test article included IMLI and ballistic layers sequentially wrapped over the test calorimeter: 1) a lower 4-layer IMLI sub-assembly layer, 2) a KEVLAR ballistic layer, 3) a second 4-layer IMLI sub-assembly layer, and 4) an exposed outer NEXTEL ballistic layer. Each of the layers was maintained at a constant layer separation distance by a grid of ULTEM tripod spacers arranged as described below.

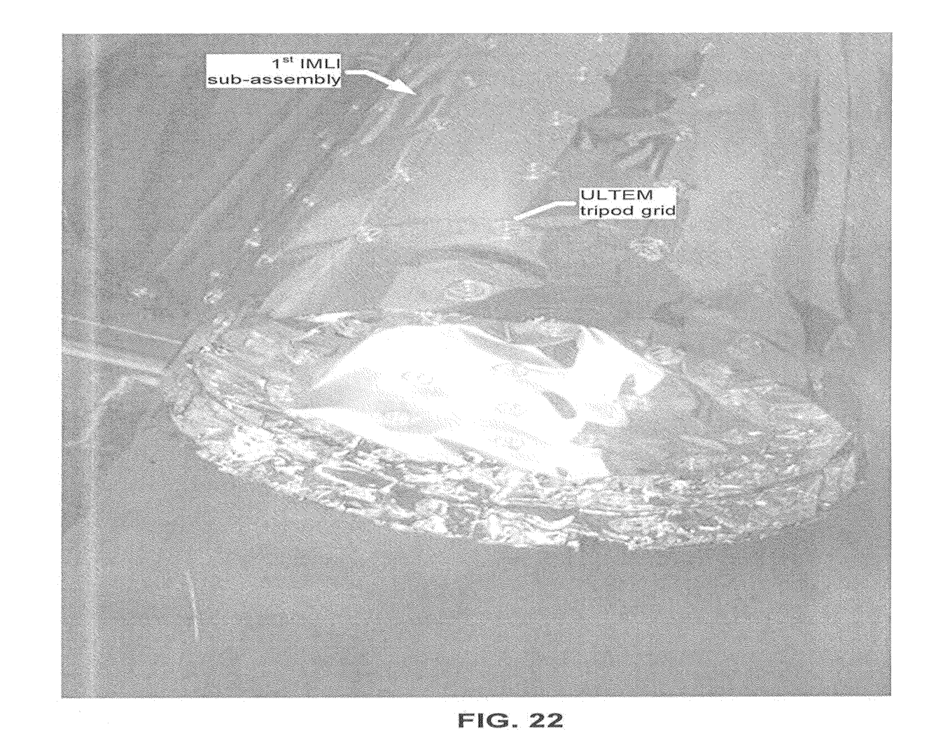

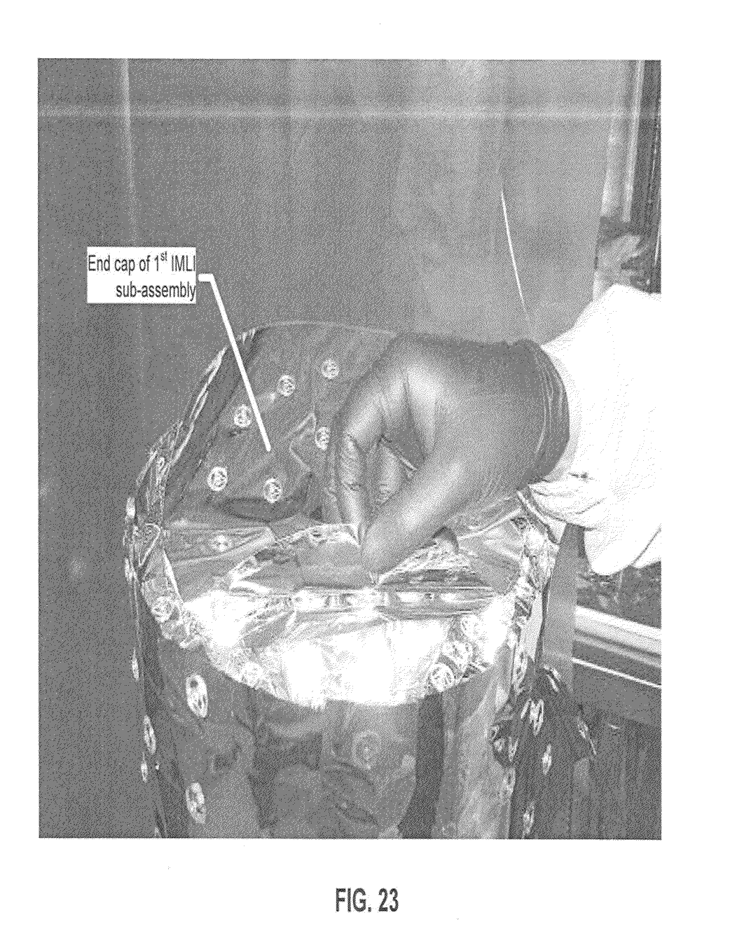

The IMLI sub-assembly layers included four MYLAR layers separated by ULTEM tripod spacers spaced in a radial pattern. Each IMLI sub-assembly layer was fabricated as a continuous sheet designed to fit the contour of the lateral wall of the calorimeter, as well as a pair of end caps. The inner IMLI sub-assembly layer wrapped around the lateral wall of the 20 L calorimeter is shown in FIG. 22. Two circular inner IMLI end caps including 4 MYLAR layers were fabricated in a similar manner to the other IMLI sub-assemblies described herein above and attached to the ends of the calorimeter, as shown in FIG. 23. The edges of the end caps were seamed to the adjacent circumferential edges of the IMLI sub-assembly wrapped around the lateral wall of the calorimeter using metallic tape.

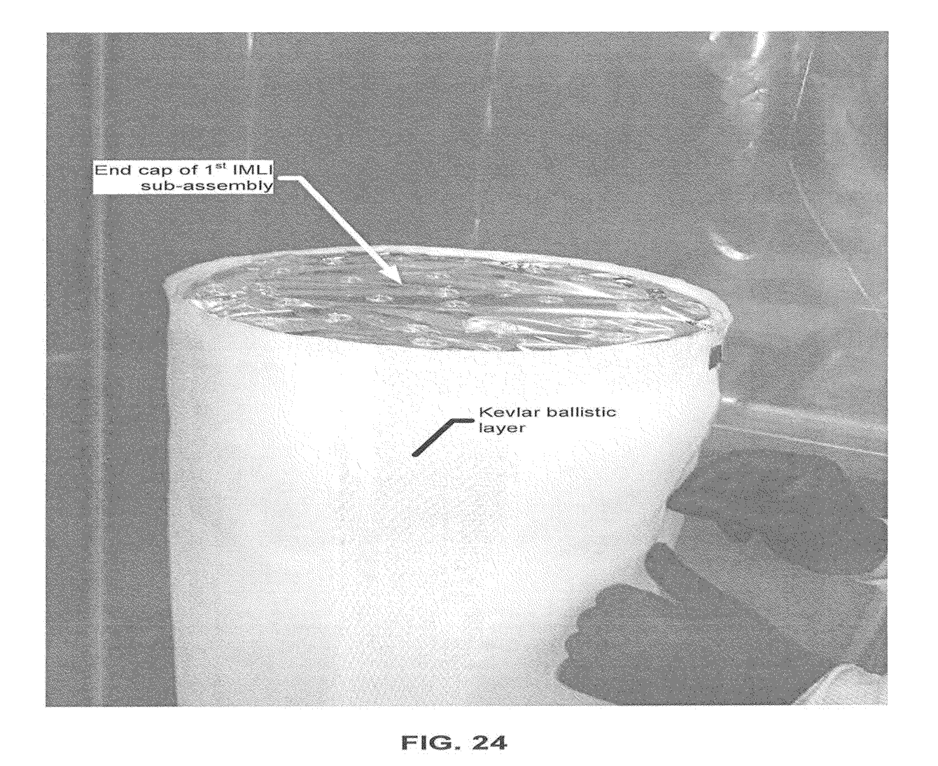

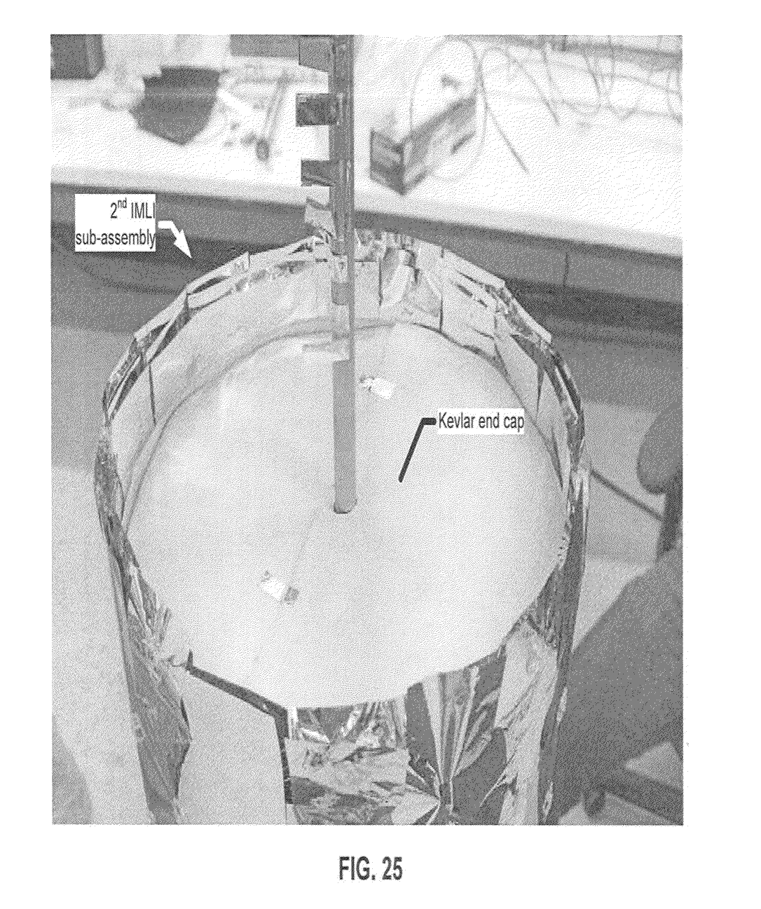

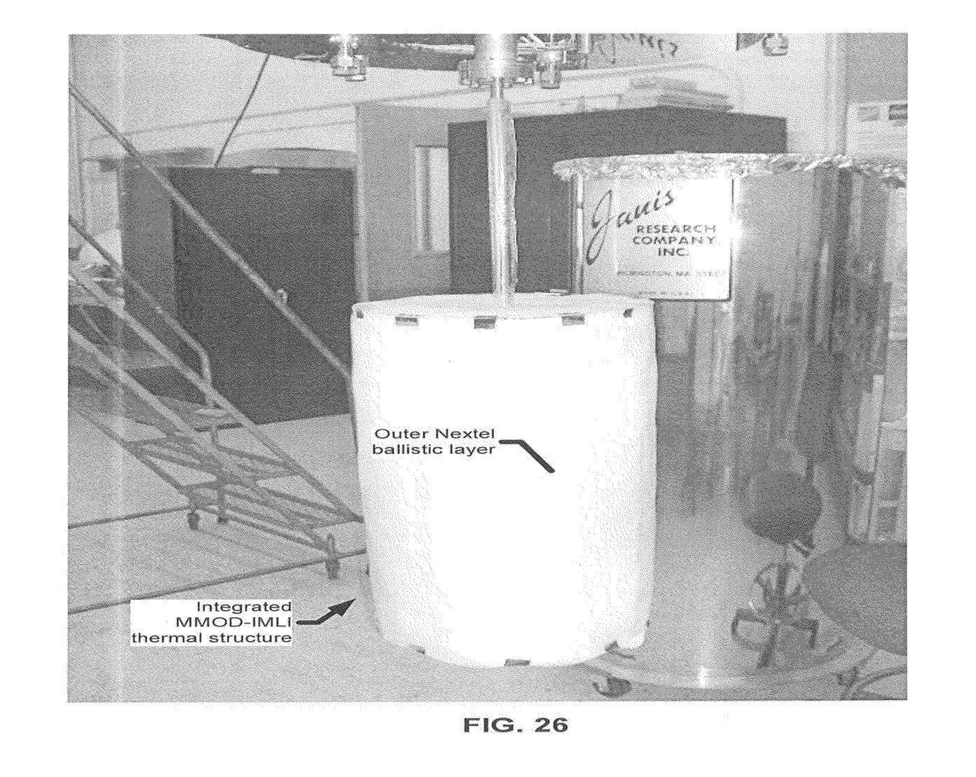

After applying adhesive to each of the exposed ULTEM tripod spacers on the surface of the inner IMLI sub-assembly layer, a KEVLAR ballistic layer was attached to the inner IMLI sub-assembly layer as shown in FIG. 24. An outer IMLI sub-assembly layer was similarly attached to the KEVLAR ballistic layer as shown in FIG. 25. Finally, an outer NEXTEL ballistic layer was similarly attached to the outer IMLI sub-assembly layer; the completed test fixture showing the exposed outer NEXTEL ballistic layer is shown in FIG. 26.

The results of the experiment demonstrated the feasibility of constructing an MMOD/IMLI thermal structure suitable for thermal testing by covering a 20 L calorimeter with an MMOD/IMLI structure.

### Example 4

### Thermal Testing of an MMOD/IMLI Thermal Structure

To assess the thermal performance of an MMOD/IMLI structure, the following experiments were conducted.

The thermal structure described in Example 3 was used for the thermal testing. The thermal structure included a 20 L cylindrical tank covered with the MMOD/IMLI structure as described in Example 3. The tank was suspended by a 0.5 inch OD fill/vent tube within a Janis cylindrical vacuum chamber. The tank pressure in the thermal structure was regulated using an MKS 640 absolute pressure controller (MKS Instruments, Andover, Mass., USA). The rate of nitrogen gas boil-off was measured using a 1 L/rev wet test meter (Elster American Meter). The liquid level in the 20 L tank was also measured by observing the frost line on a black rod placed down the fill/vent tube.

The thermal structure was placed in the vacuum chamber and the chamber was evacuated to a vacuum pressure of 2.0×10⁻⁶ torr. The tank was filled with liquid nitrogen (LN2) through a 0.25 inch tube inserted into the fill/vent tube of the thermal structure. The 20 L tank was then allowed to vent until the flow rate slowed to approximately steady flow rate. The pressure controller was then installed on the vent line along with the WTM. The pressure controller was set initially at 650 torr and later at 660 torr. Flow rate data was then obtained until a steady state flow rate was achieved with the tank close to full and with the MKS 640 maintaining a steady pressure.

The average steady flow rate as measured by the WTM was 0.249 grams/min, corresponding to an average steady heat flux of about 1.58 W/m², assuming a 0.53 m² log mean surface area.

The results of this experiment indicated that the prototype MMOD/IMLI structure that included two four-layer IMLI sub-assemblies, a KEVLAR ballistic layer, and a NEXTEL ballistic layer limited the steady heat flux to about 1.58 W/m².

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

What is claimed is:

1. A micrometeoroid and orbital debris/integrated multi-layer insulation (MMOD/IMLI) structure comprising:
a first ballistic layer;
a plurality of first spacers supporting the first ballistic layer; and
an IMLI sub-assembly comprising:
a first thermal radiative barrier layer;
a plurality of second spacers supporting the first thermal radiative barrier layer;
a second thermal radiative barrier layer adjacent to the plurality of second spacers opposite to the first thermal radiative barrier layer; and
a plurality of third spacers supporting the second thermal radiative barrier layer;
wherein the structure simultaneously provides shielding against high-velocity projectiles and thermal insulation to the equipment surface.

2. The structure of claim 1 wherein:
the first ballistic layer comprises a first ballistic lower surface opposite to a first ballistic upper surface, wherein the first ballistic lower surface faces the equipment surface;
each first spacer is attached to the first ballistic lower surface, and the plurality of first spacers is arranged in a first grid pattern;
the first thermal radiative barrier comprises a first IMLI upper surface opposite to a first IMLI lower surface, wherein the first IMLI lower surface faces the equipment surface;
each second spacer is attached to the first IMLI lower surface, and the plurality of second spacers is arranged in a second grid pattern;
the second thermal radiative barrier layer comprises a second IMLI upper surface opposite to a second IMLI lower surface, wherein the second IMLI upper surface is situated adjacent to the plurality of second spacers opposite to the first IMLI lower surface; and
each third spacer is attached to the second IMLI lower surface, and the plurality of third spacers is arranged in a third grid pattern.

3. The structure of claim 2, wherein:
the first IMLI upper surface is attached to each first spacer opposite to the first ballistic lower surface; and
the second IMLI upper surface is attached to each second spacer opposite to the first IMLI lower surface.

4. The structure of claim 3, wherein the equipment surface is attached to each third spacer opposite to the second IMLI lower surface.

5. The structure of claim 2, wherein:
the first ballistic upper surface is attached each third spacer opposite to the second IMLI lower surface; and
the second IMLI upper surface is attached to each second spacer opposite to the first IMLI lower surface.

6. The structure of claim 5, wherein the equipment surface is attached to each first spacer opposite to the first ballistic lower layer.

7. The structure of claim 2, further comprising:
at least one intermediate thermal radiative barrier layer situated between the first thermal radiative barrier layer and the second thermal radiative barrier layer, each of the at least one intermediate thermal radiative barrier layers comprising:
an intermediate IMLI upper surface opposite to an intermediate IMLI lower surface, wherein the intermediate IMLI lower surface faces the equipment surface; and
a plurality of additional spacers supporting the at least one intermediate thermal radiative barrier layer.

8. The structure of claim 7, wherein each additional spacer is attached to the intermediate IMLI lower surface and the plurality of additional spacers form an additional grid pattern.

9. The structure of claim 8, wherein the uppermost intermediate IMLI upper surface is attached to each second spacer opposite to the first IMLI lower surface and each additional intermediate IMLI upper surface is attached to an adjacent plurality of additional spacers opposite to an adjacent intermediate IMLI lower surface attached to the adjacent plurality of additional spacers.

10. The structure of claim 9, further comprising at least one intermediate layer chosen from an additional ballistic layer and an additional IMLI subassembly and further comprising a plurality of intermediate spacers supporting the at least one intermediate layer, wherein the at least one intermediate layer is situated between the first ballistic layer and the IMLI sub-assembly.

11. The structure of claim 10, wherein:
the additional ballistic layer comprises a first additional ballistic upper surface opposite to a first additional ballistic lower surface;
the first additional ballistic lower surface faces the equipment surface;
each intermediate spacer of the plurality of intermediate spacers is attached to the first additional ballistic lower surface; and
the plurality of intermediate spacers is arranged in an intermediate grid pattern.

12. The structure of claim 10, wherein:
the additional IMLI subassembly comprises
a first additional IMLI layer comprising a first additional IMLI upper surface and a first additional IMLI lower surface, wherein the first additional IMLI lower surface faces the equipment surface;
a plurality of first additional IMLI spacers supporting the first additional IMLI layer, wherein each first additional IMLI spacer is attached to the first additional IMLI lower surface, forming a first additional IMLI grid pattern; and
a second additional IMLI layer comprising a second additional IMLI upper surface and a second additional IMLI lower surface, wherein the second additional IMLI upper surface is situated adjacent to the plurality of first additional IMLI spacers opposite to the first additional IMLI lower surface, and each intermediate spacer is attached to the second additional IMLI lower surface, forming an intermediate grid pattern.

13. The structure of claim 10, wherein the first ballistic layer and the additional ballistic layer comprise a sheet of a ballistic material chosen from NEXTEL; SPECTRA fiber; fiberglass; aluminum plating; ceramic panels; ballistic armor materials; laminate armor materials comprising layers of metals, ceramics, plastics, and any combination thereof; KEVLAR; SPECTRA fiber; and TECHNORA.

14. The structure of claim 13, wherein the first ballistic layer comprises a sheet of NEXTEL.

15. The structure of claim 14, wherein the additional ballistic layer comprises a sheet of KEVLAR.

16. The structure of claim 12, wherein the first thermal radiative barrier layer, the second thermal radiative barrier layer, each intermediate thermal radiative barrier layer, the first additional IMLI layer, and the second additional IMLI layer comprise a sheet of a barrier material chosen from silverized MYLAR, goldized MYLAR, aluminized MYLAR, silverized KAPTON, goldized KAPTON, aluminized KAPTON, vanadium oxide-coated MYLAR, vanadium oxide-coated KAPTON, MYLAR with attached quantum dots, KAPTON with attached quantum dots, aluminum foil, and tungsten foil.

17. The structure of claim 12, wherein each first spacer, second spacer, third spacer, additional spacer, intermediate spacer, and first additional IMLI spacer comprises a support structure comprising a plurality of arms connecting a base defining the spacer bottom surface and a top defining the spacer top surface

18. The structure of claim 17 wherein the support structure is compressible, the plurality of arms comprise at least three deformable arms and the base structure defines a ring, the support structure further comprising a protrusion extending from the spacer top surface wherein:
a distal end of the protrusion opposite to the spacer top surface contacts a lower layer surface whereby the ring is supported, defining a minimum compressed distance between the top surface and the bottom surface when the compressible structure is in a compressed state; and
the distal end of the protrusion is separated from the lower layer surface when the compressible structure in an uncompressed state.

19. The structure of claim 18, wherein each compressible structure further comprises a spacer material chosen from: a molded polymer material comprising polyetherimide, polyimide, polyamide-imide, polyethyl ketone or wholly aromatic copolyesters; and a high-temperature material comprising alumina or ceramic.

20. The structure of claim 18, wherein the compressible structure further comprises a distance between the top surface and the bottom surface ranging from about 40 mils to about 80 mils in the uncompressed state and a maximum diameter ranging from about 40 mils to about 500 mils.

21. The structure of claim 18, wherein each compressible structure further comprises a minimum compressed distance ranging from about 10 mils to about 30 mils.

22. The structure of claim 2, wherein the structure further comprises a first lateral edge and a second lateral edge, wherein the first lateral edge is seamed with the second lateral edge.

24. The structure of claim 23, wherein the first lateral edge and the second lateral edge are seamed using a joining method chosen from sewing, bonding, snapping, interleaving, taping, and any combination thereof.

25. The structure of claim 24, wherein the first ballistic layer, the first thermal radiative layer, and the second thermal radiative layer are interleaved at the seamed first lateral edge and second lateral edge.

25. The structure of claim 12, wherein all included grid patterns chosen from the first grid pattern, the second grid pattern, the third grid pattern, the additional grid pattern, the intermediate grid pattern, and the first additional IMLI grid pattern are vertically aligned.

26. The structure of claim 12, wherein adjacent grid patterns of all included grid patterns chosen from the first grid pattern, the second grid pattern, the third grid pattern, the additional grid pattern, the intermediate grid pattern, and the first additional IMLI grid pattern are vertically offset.

27. The structure of claim 12, wherein each plurality of spacers within a single-layer grid pattern chosen from the first grid pattern, the second grid pattern, the third grid pattern, the additional grid pattern, the intermediate grid pattern, and the first additional IMLI grid pattern are interconnected by a plurality of beams, wherein each beam comprises a first end attached to a spacer and further comprises a second end attached to a neighboring spacer in the single-layer grid pattern.

28. The structure of claim 12, wherein the first ballistic layer, the additional ballistic layer the first thermal radiative barrier layer, the second thermal radiative barrier layer, each intermediate thermal radiative barrier layer, the first additional IMLI layer, and the second additional IMLI layer, each first spacer, second spacer, third spacer, additional spacer, intermediate spacer, and first additional IMLI spacer are metalized, and wherein the structure further provides electrical shielding chosen from electrical grounding, shielding from electromagnetic interference, and shielding from static electricity.

29. A method for simultaneously insulating an equipment item comprising an equipment surface and shielding the equipment surface against high-velocity projectiles, the method comprising:
providing an MMOD/IMLI structure comprising a ballistic layer, an IMLI subassembly comprising a lower IMLI surface, and a plurality of spacers supporting the lower IMLI surface, wherein the plurality of spacers are arranged in a grid pattern; and
situating the MMOD/IMLI structure over the equipment surface.

30. The method of claim 29, further comprising the MMOD/IMLI to the equipment surface.

31. The method of claim 30, wherein each spacer of the plurality of spacers is a compressible structure, the MMOD/IMLI structure assumes a compressed state when each spacer is compressed, the MMOD/IMLI structure assumes an uncompressed state when each spacer is uncompressed, and the method further comprises:
maintaining the MMOD/IMLI in a compressed state in a first location of the equipment item to reduce volume of the MMOD/IMLI structure; and
changing the MMOD/IMLI state from a compressed state to an uncompressed state in a second location.

32. The method of claim 31, wherein the MMOD/IMLI structure further comprises a first lateral edge and a neighboring second lateral edge and the method further comprises seaming the first lateral edge to the neighboring second lateral edge.

33. The method of claim 32, wherein the first lateral edge and the neighboring second lateral edge are seamed using a joining method chosen from sewing, bonding, snapping, taping, interleaving, and any combination thereof.

34. A micrometeoroid and orbital debris/integrated multi-layer insulation (MMOD/IMLI) structure comprising at least one flexible ballistic layer and at least one flexible thermal insulation layer, the at least one flexible ballistic layer and the at least one flexible thermal insulation layer separated by a plurality of spacers, the plurality of spacers defining at least one leg extending obliquely between the at least one flexible ballistic layer and the at least one flexible thermal insulation layer.

35. The MMOD/IMLI structure of claim 34 wherein the at least one leg comprises three deformable legs defining a tri-pod configuration, the tri-pod configuration including a ring supporting the legs.

36. The MMOD/IMLI structure of claim 35 wherein the at least one flexible thermal insulation layer comprises a plurality of flexible thermal insulation layers, the plurality of spacers includes a first set of spacers positioned between the at least one flexible ballistic layer and a first layer of the plurality of flexible thermal insulation layers, the plurality of spacers further includes a second set of spacers positioned between the first layer of the plurality of thermal insulation layers and a second layer of the plurality of flexible thermal insulation layers, and the first set of spacers and the second set of spacers are positioned in substantial alignment.

37. The MMOD/IMLI structure of claim 36 wherein the first set of spacers are attached to the flexible ballistic layer and the first layer of the plurality of flexible thermal insulation layers, and the second set of spacers are attached to the first layer and the second layer of the plurality of flexible thermal insulation layers.

38. The MMOD/IMLI structure of claim 37 wherein the substantially aligned spacers of the first set of spacers and the second set of spacers in combination with at least the first layer of the thermal insulation layers attached between the first set of spacers and the second set of spacers provides a discontinuous thermal path between an insulated medium situated at a first side of the MMOD/IMLI structure and an external environment situated at a second side, opposite the first side, of the MMOD/IMLI structure.

39. The MMOD/IMLI structure of claim 38 further comprising at least one second flexible ballistic layer and at least one second flexible thermal insulation layer, with the at least one flexible thermal insulation layer and the at least one second flexible thermal insulation layer positioned between the at least one flexible ballistic layer and the at least one second flexible ballistic layer.

40. The MMOD/IMLI structure of claim 35 wherein the at least one flexible thermal insulation layer comprises a plurality of flexible thermal insulation layers, the plurality of spacers including a first set of spacers positioned between the at least one flexible ballistic layer and a first one of the plurality of flexible thermal insulation layers, the plurality of spacers including a second set of spacers positioned between the first one of the plurality of thermal insulation layers and a second thermal insulation layer of the plurality of flexible thermal insulation layers, the first set of spacers and the second set of spacers staggered such that at least one spacer from the first set of spacers and at least one spacer from the second set of spacers are not aligned.
